(19) United States
(12) Patent Application Publication
(10) Pub. No.: US 2005/0004885 A1
(43) Pub. Date: Jan. 6, 2005

(54) Document/form processing method and apparatus using active documents and mobilized software

(76) Inventors: Suresh S. Pandian, Cupertino, CA (US); Thyagarajan Swaminathan, Cupertino, CA (US); Johnson Pushpanathan, Cupertino, CA (US); Krishna K. Srinivasan, Fremont, CA (US); Randal J. Martin, Naples, FL (US)

Correspondence Address: NIXON & VANDERHYE, PC, 1100 N GLEBE ROAD, 8TH FLOOR, ARLINGTON, VA, 22201-4714, US

(21) Appl. No.: 10/837,889

(22) Filed: May 4, 2004

Related U.S. Application Data
(63) Continuation-in-part of application No. 10/361,853, filed on Feb. 11, 2003.
(60) Provisional application No. 60/563,799, filed on Apr. 21, 2004.

(51) Int. Cl. G06F 7/00

(52) U.S. Cl. 707/1

(57) ABSTRACT

A server embeds typically static documents with program code enabling, for example, a form to intelligently route itself to a desired destination, to prompt a user to respond to particular questions, to perform validation operations, and to present various pull down list choices from which a user may select. Such an “active document” preferably has the capability of presenting a questionnaire to a user and to consolidate responses to the questionnaire. The active document-based questionnaire may be designed such that different questions are automatically sent to different recipients. A wide variety of applications are described including product sales lead generation and product marketing to enable the collection and optimal distribution of information regarding potential customer names, feedback concerning opinions about the product.

### CROSS-REFERENCE TO RELATED APPLICATION

This application is a continuation-in-part of application Ser. No. 10/361,853, filed on Feb. 11, 2003, entitled “Facsimile/Machine Readable Document Processing and Form Generation Apparatus and Method” which application is hereby incorporated by reference in its entirety. This application claims the benefit of Provisional Application No. 60/563,799, filed Apr. 21, 2004, the entire content of which is hereby incorporated by reference in this application.

### FIELD OF THE INVENTION

The invention generally relates to document processing and distribution systems and methodology. More particularly, the invention relates to a system and method for enabling the electronic capture and transmission of a wide variety of forms in many formats in a manner which streamlines collaboration between organizations and/or between organizations and individual users.

### BACKGROUND AND SUMMARY OF THE INVENTION

Portable Document Format (PDF) is widely used for the secure and reliable distribution and exchange of electronic documents and forms around the world. PDF is a universal file format that preserves the fonts, images, graphics, and layout of any source document, regardless of the application and platform used to create it. Adobe® PDF files can be shared, viewed, and printed by anyone with Adobe Reader® software.

Governments and enterprises around the world have adopted PDF to streamline document management, increase productivity, and reduce reliance on paper. For example, PDF is a standard format for the electronic submission of drug approvals to the U.S. Food and Drug Administration (FDA), and for electronic case filing in U.S. federal courts. It is also used by the governments of the United Kingdom and Germany for electronic document exchange.

PDF documents are often electronically communicated between individuals, for example, via e-mail. These PDF file format documents typically tend to be passive documents which reflect a series of printed pages.

A recipient of a PDF file is able open such a file, read the file and print the file to obtain a hard copy. Such files generally may be regarded as static files, i.e., an electronic version of a printed document.

In accordance with an exemplary embodiment of one aspect of the present invention, such typically static documents are embedded with program code enabling, for example, a form to intelligently route itself to a desired destination, to prompt a user to respond to particular questions, to perform validation operations, and to present various pull down list choices from which a user may select.

In accordance with an exemplary embodiment, an active document may have associated therewith a form including an embedded questionnaire. A form should be broadly viewed as including an electronic file including information solicitation-related information. Such a form would include a mechanism for providing solicited information such as, for example, blank spaces for providing requested or required information. Rather than blank spaces, other approaches may be used to permit data entry of solicited information by a recipient such as by clicking a mouse on one of several alternative choices. Such an active document preferably has the capability of presenting a questionnaire to a user and when processed at a server results in the consolidation of responses to the questionnaire. In accordance with an exemplary embodiment, the active document-based questionnaire may be designed such that the responses to different questions are automatically sent to different recipients.

The active document controls the distribution of such questions and maintains the answers thereto. For example, in a marketing campaign, a marketing agency may receive certain general compiled statistics based upon responses to questions relating to how well a corporation's product is doing in the marketplace. A corporate sales manager responsible for the product may be likewise automatically sent certain statistics pertinent to the manager's responsibilities, together with names and addresses of individuals to be contacted in relation to purchasing and/or marketing the product. Additionally, feedback obtained from responses to questions regarding problems with the product may be sent to a product manager responsible for product quality control. Thus, in accordance with an exemplary implementation, the document itself has the embedded intelligence to perform such distribution functions.

A wide variety of applications are contemplated for the mobile software and active document methodology described herein. For example, such applications include product sales lead generation and product marketing to enable the collection and optimal distribution of information regarding potential customer names, feedback concerning opinions about the product.

The mobile software and active document methodology and apparatus of the present invention also may be applied to a wide variety of medical applications. For example, the mobile software and active document methodology described herein may be used for collecting medical history information related to new drug testing conducted by a pharmaceutical drug company.

In such a medical application, by way of example only, a doctor may fill an active document form detailing testing results. The information on such an intelligent document would be automatically routed to the appropriate places for data preservation and analysis. In this fashion, a doctor in a hospital may enter information from various patients via, for example, a tablet computer. The gathered information may then be intelligently routed to a server if an online connection may be immediately established. Alternatively, if an online connection cannot be established, the gathered information will be locally stored and will automatically be later forwarded to the server whenever the next connection is established.

The methodology described herein may be applied in wide range of product/system service applications. For example, a technician from a hardware vendor may be sent out to resolve a particular problem with the vendor's product. The technician having a laptop with a wireless communication capability may retrieve an active document form via which the technician may request a particular replacement part. The active document and mobilized software embedded in the form would be utilized to automatically establish a connection to the technician's home base or automatically save answers to questions which will be automatically forwarded to the home base once a wireless connection is established. Such operation would occur without the technician having to perform any required operation other than completing and submitting the intelligent form.

In this exemplary embodiment, from the user's point of view, communication appears to be seamless since the user need not personally establish a network connection. Thus, the technician, after submitting the document, does not have to be concerned with whether a connection is actually established or not since the active document will automatically ensure ultimate communication with the home base.

### BRIEF DESCRIPTION OF THE DRAWINGS

These, as well as other features of the present exemplary embodiments will be better appreciated by reading the following description of the preferred embodiments of the present invention taken in conjunction with the accompanying drawings of which

FIG. 1 is a logical architecture overview of the major hardware/software systems in accordance with an exemplary embodiment of the present invention.

FIG. 2 is a high level block diagram showing system components in accordance with an exemplary embodiment of the present invention.

FIG. 3 is a block diagram which shows in further detail certain aspects of an illustrative system architecture in accordance with an exemplary embodiment of the present invention.

FIG. 4 is a work flow diagram delineating the sequence of operations performed during the document conversion process in an exemplary embodiment.

FIG. 5 is a block diagram which demonstrates exemplary steps employed by one or more of the servers in the FIG. 3 system in an active document application.

FIG. 6 is an exemplary flow diagram depicting the various stages through which an active document eForm may undergo from its creation to its utilization.

FIG. 7 is a block diagram showing an active document server architecture and associated input and output receipt and distribution.

FIG. 8 is a block diagram that illustrates a system for applying the active document methodology in a customer relations management application.

FIG. 9 is a block diagram showing an exemplary active document eForms platform in a business application system.

FIG. 10 is a block diagram depicting operations performed by the program management subsystem.

FIG. 11 is a block diagram depicting operations performed by the partner management subsystem.

FIG. 12 is a block diagram depicting operations performed by the questionnaire management subsystem.

FIG. 13 is block diagram depicting operations performed by the template management subsystem.

FIG. 14 is block diagram depicting operations performed by the active document management subsystem.

FIG. 15 is block diagram depicting operations performed by the active document distribution management subsystem.

FIG. 16 is a flowchart delineating the sequence of operations involved in creating a questionnaire.

FIG. 17 is a flowchart indicating the sequence of operations involved in modifying a questionnaire.

FIG. 18 is a flowchart delineating the sequence of operations involved in creating a template.

FIG. 19 is a flowchart indicating the sequence of operations involved in modifying a template.

FIG. 20 is a flowchart indicating the sequence of operations involved in downloading software.

FIG. 21 is a flowchart delineating the sequence of operations involved in publishing an active document.

FIG. 22 is a flowchart delineating the sequence of operations involved in track lead processing.

FIG. 23 is a flowchart delineating the sequence of operations involved in lead distribution configuration.

FIG. 24 is an exemplary questionnaire of a company Port Packaging.

FIG. 25 is a screen display illustrating the selection of questionnaire categories.

FIG. 26 is an exemplary screen display showing illustrative questionnaires that may be selected.

FIG. 27 is an exemplary screen display showing the capturing of a title, introduction and closing comments.

FIG. 28 is an exemplary screen display showing illustrative survey presentation styles that may be selected.

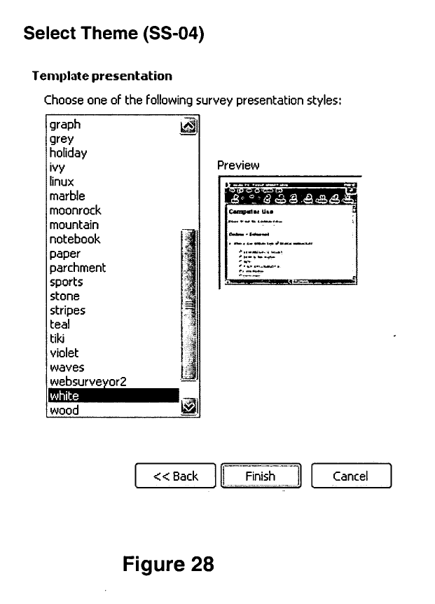

FIG. 29 is an exemplary screen display showing various questions in a questionnaire which may be selected for editing.

FIG. 30 is an exemplary screen display illustrating the editing of a questionnaire question.

FIG. 31 shows an exemplary screen display in which a question style may be selected.

FIG. 32 shows an exemplary screen display in which a question text and response text may be entered.

FIG. 33 shows an exemplary screen display illustrating the selection of questions from a question library.

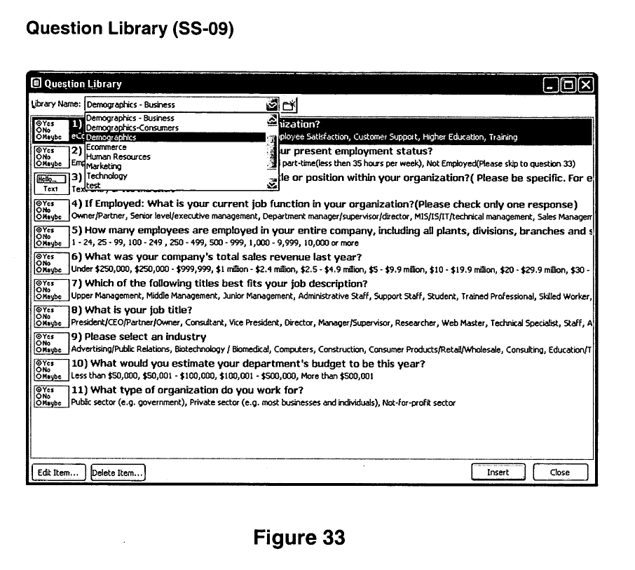

FIG. 34 is an exemplary screen display showing a displayed template that has been created.

FIG. 35 is an illustrative screen display showing a questionnaire with questions and various editing features.

FIG. 36 is an exemplary screen display showing the specification of a template font size and color.

FIG. 37 is an exemplary screen display illustrating the selection of a template.

### DETAILED DESCRIPTION OF THE PRESENT AND PREFERRED EMBODIMENTS

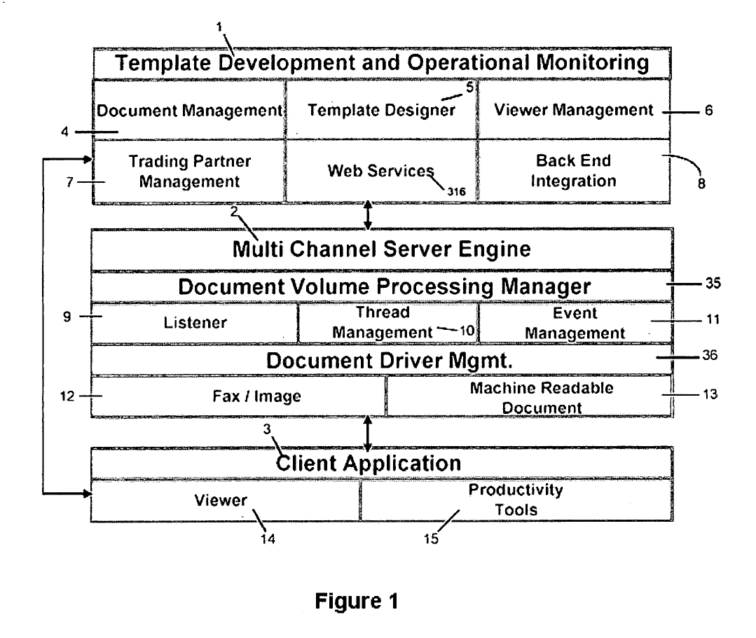

FIG. 1 is a high level overview of an exemplary organization of major hardware and software components in accordance with one exemplary embodiment. Exemplary system components are described in detail in parent application Ser. No. 10/361,853, which application has been incorporated herein by reference in its entirety. As shown FIG. 1, a template development and operational monitoring system 1 operates to manage documents which are received, and to design templates. As will be explained in detail below, in accordance with an exemplary embodiment, active documents are created to result in “mobile” forms that can be completed on or off line. These forms have the ability to submit themselves directly via web services if online. These active documents have the built-in intelligence to queue themselves and utilize, for example, email functionality or other methods of queuing which provide a guaranteed delivery of exactly one instance of the data.

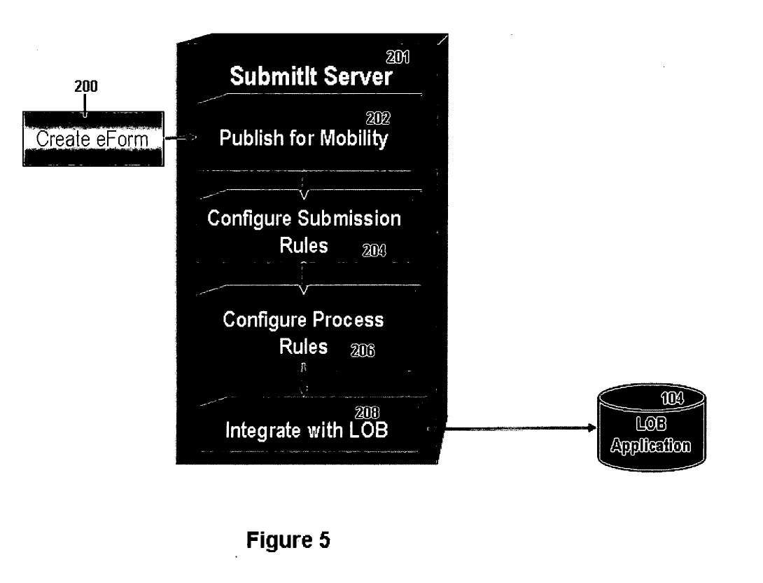

Prior to explaining the active document and mobile software aspects of the exemplary embodiments beginning with the description of FIG. 5, various hardware and software system components employed in an illustrative embodiment are first described. The template development and operational monitoring system 1 is coupled to a multi-channel server engine 2 which, for example, in addition to active document processing tasks described below, converts the output of the template development system 1 into a document in the proper form such as, for example, an XML document which in turn can be converted into a final form such as, for example, an EDI document. Additionally, a multi-channel engine client application 3 interacts with multi-channel server engine 2 to assist in performing error detecting/correcting activities while viewing documents being processed. Client application 3 also interacts with the template development system 1 as will be explained further below.

It should be understood that the subsystems shown in the template development system 1, the multi-channel server engine 2, and the client application system 3 are shown, for illustration purposes only, to explain certain aspects of the exemplary embodiments of the present invention. Certain modules may, for example, be combined with others, performed in another portion of the system or be left out of the system in a given implementation.

Turning back to the template development and operational monitoring system 1, this system supports the processing and management of received documents of any of a wide variety of types. The document management system 4, template designer 5, and viewer management system 6 coact in the document template development and setup process. Document management system 4 retrieves documents from a queue and identifies the type of document, e.g., Microsoft Word document, PDF document or image document, for further processing.

The template designer 5 creates documents that are managed by the document management system 4. The template designer 5 stores and retrieves documents and applies predefined rules for generating a template document. In designing a template document, various characteristics of an input document are mapped to predefined portions of the template document. As part of the template design process, a viewer management system 6 controls the display of the customer's input form and the template being generated during the template design process. Thus, through split screen techniques, a user can see both the original document and the resulting template created by mapping fields from the originating document onto the template.

The trading partner management system 7 links, for example, a customer (trading partner) who is forwarding, for example, a purchase order with the purchase order format that is characteristic of that customer. The overall system in FIG. 1 then operates to convert the format typical of the customer to a normalized XML based purchase order format in accordance with, for example, EDI. Thus, for example, each corporate customer using the system, in accordance with an exemplary embodiment, may utilize its own distinct internal purchase order format, which may be transmitted, for example, via facsimile. Each of the disparate purchase order formats will be converted into a common standard format for further processing. Thus, the trading partner management system 7 links a customer identification with the customer's document format such that appropriate conversion rules may be applied to convert such a format to a standard format such as EDI. Back end integration system 8 operates to deliver the document to the required destination.

The customer may choose to transmit documents via, for example, a common email system. However, the overall system shown in FIG. 1 supports web services 316 as an alternative method for submitting documents. Documents submitted via web services 316 provide for additional control and security. Besides document submission, any external data, for example trading partner registration information, may be submitted to the overall system via web services 316.

Turning next to the multi-channel server engine 2, this engine includes a document volume processing manager 35 which includes a listener (document extractor/monitoring system) 9, which monitors when documents have arrived for processing. The listener 9 detects the arrival of the documents and the document type. A thread management system 10 performs the necessary processing to ensure that the application is readily scalable. For example, if documents are received every two minutes, no enhanced processing capability for high volume is required. However, if documents are received at extremely high volume, the system hardware should be capable of processing at speeds required to properly handle such volume. The thread management system 10 ensures that processing capability will scale up as necessary. For example, if the system hardware includes multiple processors, then multiple threads may be processed in parallel.

An event management system 11 responds to various events such as, for example, the receipt of a document and triggers the required operation to be performed. The event management system 11 also responds to the detection of an error event.

The server engine 2 also includes a document driver management system 36. The document driver system 36 includes distinct driver software depending upon the nature of the document. The document driver management system 36 is used to dispatch the appropriate parser depending on the document type submitted by the customer, for example a FAX, Word, PDF, XFORM or some other format.

Such driver software includes fax/image document driver software 12 and machine readable document driver software 13. Thus, document processing will differ depending upon whether the document is determined to be a fax or image document or a machine readable document (which would include, for example, a word document or any other type of machine readable document).

In accordance with an exemplary embodiment, the system additionally includes a client application system 3 which may be embodied in a PC and includes a viewer subsystem 14 and productivity tools 15. The viewer subsystem 14 permits a user to view an original document and a document undergoing conversion to a standard document format. The client application 3 provides the system user with a set of productivity tools 15 depending upon the role of the user in the corporate environment and access capability built into the user's password. Productivity tools may permit a user to design templates, manage documents, correct documents, etc., based on the user's access authority. The client application module 3 interacts with both the template development system 1 and the multi-channel server engine 2.

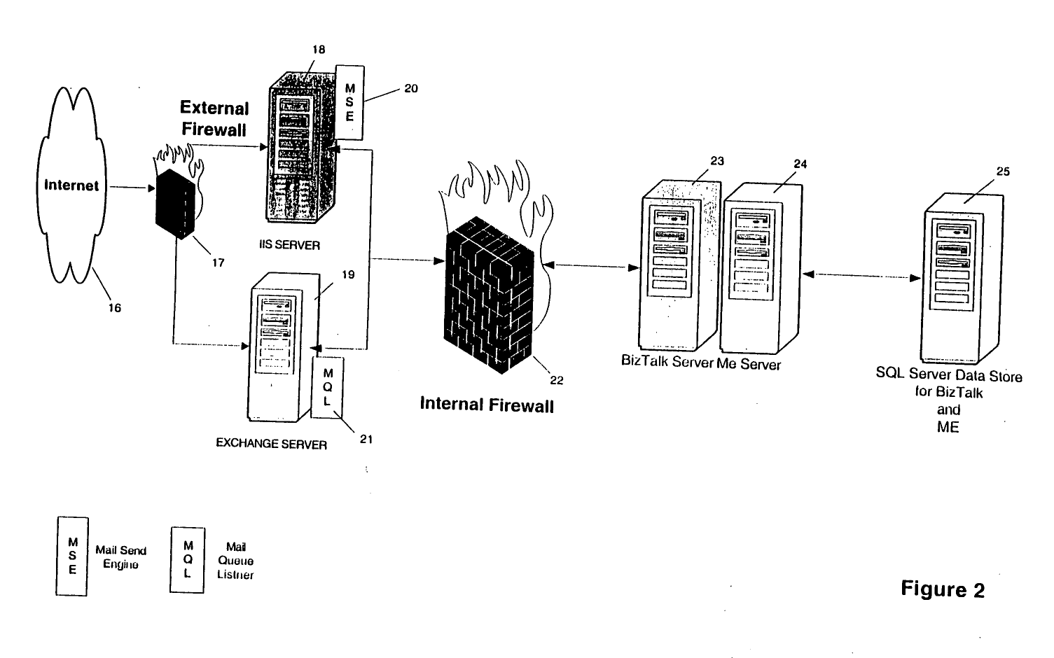

FIG. 2 is a high level block diagram showing illustrative system components in accordance with an exemplary embodiment of the present invention. As will be explained further below, various types of documents may, for example, be received via the Internet 16. An external firewall 17 is utilized to prevent unauthorized access to system servers. In accordance with an exemplary embodiment of the present invention, the external firewall may run a non-Windows operating system to confuse intruders. A conventional IIS server 18 is used to manage web pages and web access. An exchange server 19 is utilized as the initial repository for incoming documents. Associated with IIS 18 is a mail send engine (MSE) 20. Associated with the exchange server 19 is a mail queue listener (MQL) 21, which retrieves mail from a mail queue and determines, for each retrieved e-mail, the number of attachments that are associated therewith. The mail queue listener 21 operates to retrieve each attached document and store the attached document in the SQL server data store 25 via the internal firewall 22 and servers 23 and 24.

Internal firewall 22 may be a conventional internal firewall within a corporate entity. The document information, after being transported via internal firewall 22 is processed and routed through a system including a conventional server 23, which for example, may be Microsoft Biztalk server, and a multi-channel engine server 24 which is described in detail below. The SQL server data store 25 is utilized by both servers as the system data repository.

The system shown in FIG. 2 supports bidirectional communications. Appropriate notifications to remotely located parties are sent via the Internet to end users.

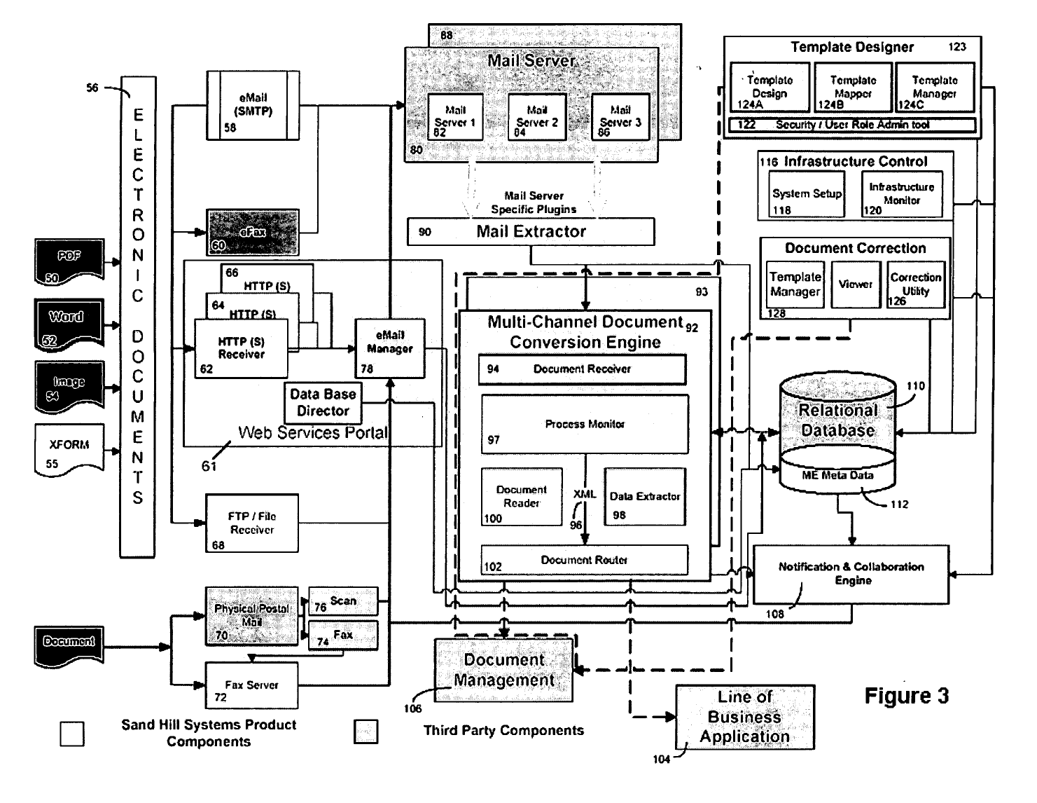

FIG. 3 is a block diagram, which shows in further detail certain aspects of an illustrative system architecture in accordance with an exemplary embodiment of the present invention. This illustrative system creates, publishes, finds, applies, captures and processes active documents incorporating mobile software as will be explained in detail below.

This illustrative system, which is described in further detail in copending application Ser. No. 10/361,853, receives, via a wide range of multi-channel inputs, any document type, such as a PDF document 50, a Word document 52 an image document 54 or an XFORMS document 55. It should be understood that other document types are also contemplated and that the four document types shown are for purposes of illustration only.

Documents to be submitted 50, 52, 54 and 55 via some electronic means (as represented by Electronic Documents 56) are delivered to the Multi-Channel Document Conversion Engine 93 by various transport technologies such as eMail 58, eFax 60, Web services Portal 61, FTP 68. Physical media such as mail 70 and fax 72 can also be submitted by converting them to electronic form via, for example, a scanner 76 or a fax server 72. In an exemplary embodiment, the input documents 56 and physical documents 70 and 72 are routed to the Mail Server(s) 80. This allows a consistent method for submission of documents to the Multi-Channel Document Conversion Engine 93, and acts as a buffer in the case of extremely high volumes of input documents. The conventional e-mail message 58, the Web services Portal 61, and the FTP/File Receiver 68 could include document attachments of a variety of identified types.

If, for example, an image document 54 is transmitted as an electronic document 56 via a commercially available electronic facsimile service such as eFax.com, the eFAX document is e-mailed to an eFax portion 60 of the e-mail system. The e-mail transmission from e-Fax 60 is likewise a routed e-mail message, but is an “eFAX” e-mail having an image (TIF) attachment, as is offered by commercially available services. The e-mail with image attachment (60) is coupled to mail server 80. Such commercially available systems operate to receive a customer's fax via a telephone communication, package the fax as an e-mail and send the e-mail as directed.

Documents received via the Internet using the http(s) protocol are coupled via the Web services Portal 61 to one of the system http(s) receivers 62, 64, or 66. Each of the http(s) receivers 62, 64, or 66 receives the electronic document transmitted via the http(s) protocol and packages the document as an e-mail transmission, which is then sent to e-mail system manager 78. Multiple http receivers are utilized under circumstances where a high volume of documents are being received, so that the system can efficiently process in parallel and at high speeds when required. The http(s) receivers 62, 64, 66 run, for example, on one or more IIS servers 18 represented in FIG. 2.

A document may be received via the file transfer protocol FTP. A file receiver 68 receives such a document file and couples the document to the e-mail manager 78. The FTP protocol is a conventional protocol which operates to send batch files to desired destinations via the Internet or via a dialup modem.

The illustrative embodiments also contemplate receipt of documents via regular mail, which will be received at a physical mail station 70. The documents received by mail may, for example, then be scanned via optical scanner 76 and coupled to the e-mail manager 78. Alternatively, documents may be converted into an electronic document via a facsimile device 74 and forwarded to a fax server 72 which couples the electronic version of the document to the e-mail manager 78. The fax server 72 may likewise receive facsimile documents directly from an external fax device. The received facsimile documents are then coupled to e-mail manager 78.

In accordance with certain illustrative exemplary embodiments, via the conversion of information received from http receivers 62, 64, or 66, FTP receiver 68 and scanned or faxed physical mail via 76, 74 and 72, the e-mail manager 78 ensures, along with the e-mail modules 58 and 60, that mail receiver 80 receives input from all sources in a common format, i.e., an e-mail with an attachment. Such an attachment may, for example, be a PDF, Word or image or any other document type. Through the use of mail servers 80, 88 which receive documents via attachments, the system operates to convert received documents into a desired standard document format on an “other than real time” basis. Thus, for applications where the standard documents must be processed as of a certain critical date, e.g., the due date for a government grant application or the due date for taxes to be submitted, the system will not be overrun by real time processing requirements resulting from the highly CPU intensive conversion process, which will be described below. In this fashion, the system may receive large numbers of e-mail communications per second, and later process the attached documents at a rate that the multi-channel engine can comfortably process. Mail server 80 may include a variety of mail servers, such a mail server 1 (82), which may be a Microsoft exchange server, or mail server 2 (84), which may be a Lotus Domino mail server. Additionally, server 80 may include other mail servers 3 (86). Additionally, mail server 80 may be replicated in the form of mail server system 88 to permit extremely high volume input processing. The mail servers 80 and 88 correspond to the FIG. 2 exchange server 19 and further servers are contemplated if needed.

The system also includes a mail queue listener/extractor 90 which is coupled to mail servers 1, 2 and 3 (82, 84 and 86). Mail queue listener/extractor 90 retrieves the mail and determines for each retrieved e-mail, the number of attachments that are associated therewith. The mail queue listener 90 will then retrieve each attached document and store the attached document in the relational database 110 associated with server 110 which may, for example, be an MS SQL server.

Where there are multiple attachments and multiple attachment types, each attachment type such as a Word document or an image document, is processed to handle unique issues associated with each document type. For example, a Word document will likely result in a 100% successful conversion to a standard format, whereas a PDF document would be slightly less than 100%, and an image document would be converted at a still lower success rate. If an image document is being processed such that the conversion cannot be successfully completed without intervention, due to an unreadable field, but the PDF and Word document could be successfully processed, the system operates to direct the image document to error processing. For example, the image document may be transmitted to document correction facility 128, where, using the client tools correction utility 126, the image document may be viewed and corrected. Documents which are required to be corrected may be appropriately stored in, for example, data base 110.

If independent documents are received which can be presented to the desired recipient immediately after conversion, the system will follow through on that course. The mail queue listener/extractor 90 applies predefined setup rules for delivering converted documents, e.g., delivering each attachment as converted or holding until all attachments are successfully converted and appropriately storing such attachments in the database 110.

The documents are retrieved from the database 110 and are forwarded to one or more multi-channel engines 92, 93. One or more multi-channel engines 92, 93 is utilized to manage the overall core document conversion process. In an exemplary embodiment, the multi-channel document conversion engines 92 and 93 are implemented by a combination of a conventional Microsoft BizTalk server 23A and the multi-channel engine server 24 described in detail herein in the above-identified copending application, which has been incorporated herein by reference. The document router 102 shown in FIG. 3 is preferably implemented by a BizTalk server 23A.

The preferred multi-channel document conversion engines 92, 93 contemplates use of many different parsers. For example, the engines 92, 93 preferably include an image document parser, a Word document parser and a PDF parser and other types of document parsers.

The respective parsers in the multi-channel engines recognize that, for example, a purchase order has been received from a company A, which utilizes its own predetermined purchase order format, and transforms that company A purchase order format into a desired standard document form template purchase order in Extensible Markup Language (“XML”) format as represented in FIG. 3 at 96. XML is a vendor neutral industry standard language for creating self defining documents. XML lets users define and deliver data, type, and content. This makes it easier for devices and applications to search for, gather, and transport data. XML permits the intelligent presentation of data. With XML, embedded tags may be used to describe data, where the tags are user defined and identified as operational data elements. XML is transported over TCP/IP using HTTP, it is not limited to being presented in browsers; it can be delivered to other applications and databases for additional processing.

An exemplary implementation of the Multi-Channel Document Conversion Engine (MDCE) 92, 93 will now be described in further detail. The MDCE receives document objects, associates them with preconfigured conversion templates or schemas, and generates machine readable data files as output. The MDCE is indifferent to the source document types, handling images generated by fax transmission, Adobe pdf, Microsoft Office (Word, Excel), XFORMS or any other rich document. The MDCE is, in an exemplary embodiment, built in a modular fashion such that any document type can be added as a standalone component.

In accordance with an exemplary embodiment, the MDCE runs in a transactional state, guaranteeing that when a document conversion process begins, it will either complete successfully, or be rolled back to its prior state. In the case of an error, the MDCE will send out notification alerts to previously defined administrators for their attention. In accordance with an exemplary embodiment, many different types of errors will be detected by the MDCE including those which are described in the above-identified incorporated copending application.

The MDCE is built to be scalable, supporting both a horizontal and vertical hardware growth paradigm. Horizontal scalability entails having a farm of servers with each server doing individual parts. Vertical scalability entails parallel processing hardware configurations.

The system also includes a user interface for the administrator of the process, which is represented in FIG. 3 by infrastructure control 116. A server administrator is the individual responsible for monitoring the operation of the system and for ensuring that the system operates as designed. The infrastructure control 116 includes an administrator's console 118 for system setup and an Infrastructure Monitor 120 which permits the administrator to discern information about the operation of all the components of the system shown in FIG. 3 including the various servers shown, such as the mail server 80, the servers associated with the multi-channel engines 92, 93, etc. The console will indicate whether each of the servers is up and running and whether each of the computers required in the document conversion process are operating properly. The system set up 118 permits the administrator to control trading partner setup operations and other functions appropriate for a system administrator.

The system also includes, in addition to infrastructure control 116, a template designer 123 for controlling the template design process and includes all the tools necessary in the ongoing document conversion process. In accordance with an exemplary embodiment, the template designer includes a template design module 124A, which controls a wide range of template design functions involved in the creation of templates, a template mapper 124B, which controls the process of transforming an original form fields to the proper zones on an appropriate standard document template, and a template manager 124C which manages the storage and retrieval of templates and sets up the required information for the “trading partners” referred to above. The operator of the template designer 123 will have more or less tools to manipulate depending upon the individual's associated access authority controlled by security/user role module 122 based, for example, on an analysis of the user's password.

A document correction facility 127 controls the viewing and correcting of documents in which errors have been detected. The rules for accepting or detecting a document will vary in accordance with the application. For example, in a business purchase order context, the system operates to avoid rejecting orders to purchase products whenever possible. The document correction utility 127 permits on-line correction during the document conversion process resulting, for example, from an inability to read data from an original form from a customer. When detection of a document conversion failure occurs, documents are forwarded to the document correction utility 127 and dependent upon the form of a document are delivered either to a Word correction utility, a PDF correction utility or fax/image correction utility embodied in correction utility 126. With respect to each document type, the original document is displayed in one window and the attempted conversion in a second window, thereby enabling a user to identify the error and make appropriate correction where possible. The correction utility uses available correction tools associated with each document type. For example, a Microsoft Word document editor may be utilized for Word document editing and a Microsoft BizTalk screen editor 244 may be utilized during the editor/viewer association process. The Microsoft BizTalk Mapping and Microsoft BizTalk Schema Editor may be utilized for handling errors during the document mapping process, where, for example, a source document is converted into the XML format as described above. With respect to PDF document correction, the Adobe Acrobat editor may be utilized. Similarly fax/image corrections may be made using a commercially available OCR engine such as the Scansoft OCR engine.

The system includes relational database 110 which, for example, stores all setup information including all the trading partner definitions, the original document transformation information, templates, the images that have been transmitted by form submitters and the resulting XML that was generated. The relational data base also stores meta data 112.

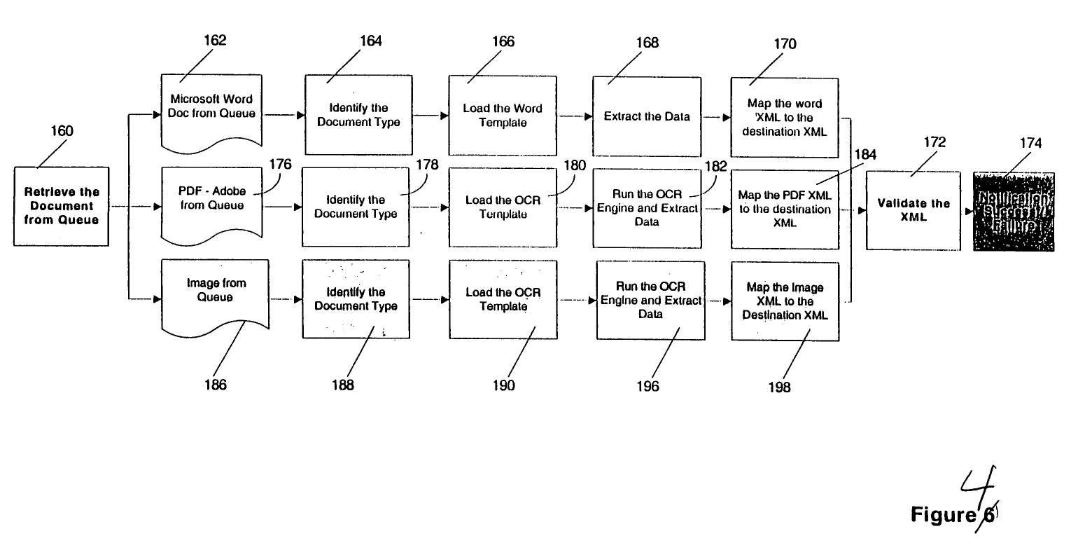

FIG. 4 is a work flow diagram delineating the sequence of operations performed in the multi-channel engine 92 during the document conversion process. As shown in FIG. 4, a document is retrieved by the mail queue listener/extractor 90 shown in FIG. 3, from the mail queue. A determination is made whether the document retrieved from the queue is, for example, a Microsoft Word document, a PDF-Adobe document or an image document and is directed to an appropriate processing sequence depending upon the document type detected. The document type may be identified in a variety of ways. For example, the document may be compared to a known document type template thereby resulting in document type identification.

If a Microsoft Word document is obtained from the queue (162), an identification is made that the document type is a Microsoft Word type document (164). Thereafter, the Word template that had been created in the template designer 123 is loaded (166). Based on the template received, the required data elements are identified, and the identified data elements are extracted from, for example, the original purchase order form submitted by a company seeking to purchase goods or services (168). The extracted data is then placed in a Word XML format and is then mapped into the standard document template in XML (170). Thereafter, the destination XML is validated to make sure all the fields such as the date field, numeric fields, etc. are correct (172). Finally, the notification of success/failure is generated (174), which is then delivered to the submitter.

If a PDF/Adobe document is retrieved from the mail queue (176), the PDF/Adobe document is identified (178). An optical scanning engine may be used to scan the PDF document obtained via the e-mail attachment or some other data extraction technique may be used. An OCR template appropriate for the PDF document is then loaded (180) or the appropriate data extraction tool is loaded. Thereafter, the OCR engine or the data extraction tool runs to extract data from the original PDF document. A PDF-XML document is generated and mapped to a destination standard XML document (184). Thereafter, as indicated above, validation and notification processes are performed (172, 174).

With respect to facsimile documents, as indicated above, one mode for receiving a faxed document is via a commercially available eFAX service. Under such circumstances, a corporate customer service representative may provide end user trading partners with a phone number for sending facsimile transmitted purchase orders. Under such circumstances, a retrieved image from the queue (186) will be recognized as a facsimile purchase order (188). Thereafter, an OCR template is loaded for eFAX transmissions (190).

The OCR engine is then run. As the document is being scanned, known zones on the scanned facsimile are identified and data is extracted (196). An image-XML document is generated and mapped to a destination standard XML document (198). Thereafter, as indicated above, validation and notification processes are performed (172, 174). If the OCR engine is scanning, for example, a known date field, the software may be designed to generate an indication of the probability of a successful read of an identified zone. Depending upon the criticality of a particular field, a high probably of success, e.g., greater than 98% may be interpreted as a successful read. A probability below the selected value will result in an error being detected and the erroneous field highlighted.

In case of detected errors, the document correction facility 127 (FIG. 3) permits corrections to be made to correct, for example, apparent problems, at which time the form may be resubmitted for conversion. Thereafter, an image XML is generated which is then mapped to the destination XML (198).

Reference is made to the above-identified incorporated copending patent application for exemplary screen displays depicting an image document in the form of a customer's original purchase order in the process of being mapped to a template standard document purchase order. The incorporated application depicts a variety of screen displays showing various exemplary applications at various stages during document processing using the above-described methodologies. For example, a screen display is shown therein which depicts the data extracted from a customer's purchase order form and inserted into a standard document purchase order template.

FIG. 5 is a block diagram which illustrates the steps employed by one or more of the servers in the FIG. 3 system to create an active document having mobilized software, which is at times referred to herein as an “eForm.” The eForm creating and/or processing server 201 for ease of identification has been referenced as the SubmitIt server, and may be implemented in any one of the heretofore mentioned servers including the BizTalk server 23 and the multi-channel engine server 24 shown in FIG. 2, which embodies the multi-channel document conversion engines 92 and 93 shown in FIG. 3.

The eForm creation process in server 201 initially involves publishing the eForm for mobility (202). The publishing and creation of a forms package involves defining the form in the server, which may involve selecting, for example, a PDF file, selecting questionnaire information for placement in the file, and identifying those places in the PDF file where, for example, an intelligent questionnaire may be inserted. By way of example only, if the PDF file represents a textbook, a questionnaire may be inserted at the end of each textbook chapter to provide chapter tests for students. The questionnaire may ask questions, prompt students for answers and then automatically route the resulting test to an appropriate party. It should also be recognized that for this and many other applications, the answer properties can be controlled by adding some additional validation script. The typical examples are whether the answer is mandatory, what can be range of answers, etc.

The Eform publishing process 202 further involves adding a form ID to the PDF form so that it may be later accessed and identified.

The creation of an active document, i.e., eFORM, results in an exemplary embodiment adding JAVA script to the PDF document to translate the document from being a passive PDF to an intelligent document by adding program logic into the document. PDF files and JavaScript is one example of electronic form type and program logic which may be combined to form an intelligent document. Alternatively, for example, Microsoft Word documents may be combined withMicrosoft's Virtual Basic Script (VBScript). In a similar fashion, Microsoft Excel, or Microsoft InfoPath may be used with, for example, VBScript. Other contemplated technologies include MacroMedia Flash, PERL script, and XForms may be utilized.

Various users messages may also be added to the PDF file. For example, various error messages and status messages may be incorporated into the document. Usage rights may be established for the form user. For example, a user may be given the right to complete an eform, add comments, save the eForm locally, print the eForm, or digitally sign and submit an eForm.

In accordance with an illustrative embodiment, the embedding of Java script into the PDF form results in some level of form mobility. Thus, for example, the Java script may test to determine whether the system is online. If the system is online, the document may be immediately routed via, for example, the Internet to a desired location. If the system is not online, the form may be routed through e-mail or though some other store and forward mechanism, for example, the Java Message Queue. The document may be routed, for example, via the document router 102, shown in FIG. 3.

The server 201, in creating the eForm (200), configures submission rules (204). The submission rules for an eForm incorporate validation rules which must be satisfied prior to allowing a document to be submitted. For example, an eForm would not be in the proper format to be submitted if it were incomplete in some significant respect, such as the omission of mandatory information. The submission rules 204 may also, for example, include routing information for use in determining the location of a destination server targeted to receive the created eForm, and various recipient e-mail addresses. In accordance with an exemplary embodiment, the answer to a particular question or set of questions, in a questionnaire may be routed to one e-mail address. The answer to a different question in, for example, a different portion of the questionnaire, may be routed elsewhere.

The configuration of submission rules 204 may further involve the configuration of web services to establish a connection via, for example, the Internet or, alternatively, to configure various store and forward mechanisms, such as e-mail or to identify another temporary local store for created eForms when an online connection is unavailable. The submission rules 204 may also, for example, include an indication of whether a partial submission is required, or whether a resubmission of all or a portion of the information is allowed. The submission rules may additionally permit the configuration of an initial submission which may later be accessed, revised, and then resubmitted, for example, once more complete information has become available.

The server 201 additionally configures process rules 206 which define how a form, once created, will be processed when it is received by the server. During such processing, the server performs various validation operations to check the basic data contained in the form. For example, if the form identified the name of a drug being tested, a check may be made to determine that the drug bears a name that server 201 has been previously programmed to be recognized. If such basic data validation checks indicate that the form must be rejected, the end user is sent an appropriate notification. A failure of a basic data validation check may trigger routing the form to a quality control site, where the detected error may be corrected. An end user may also receive notification, upon the server's receipt of the form, that the form had been received. Various post processing checks of the eForm may also be applied after processing by the server. An end user may subsequently be notified that the form had been processed successfully.

The server 201 also operates to integrate the created eForm 200 with a line of business application (208) by, for example, routing the created eForm to the appropriate line of business application shown in FIG. 3. The integration at 208 involves, for example, packaging the results of the data collected via the processed eForm, routing the form and/or the results as appropriate to a target system/device to thereby result in the form and/or results being forwarded to a purchase order system, a product ordering system, etc., depending upon the target application. The eForm, during the integration process, is processed such that its data format is converted to the format which is expected by the line of business application (LOB 104) as explained in detail above with respect to the processing taken place in conjunction with FIGS. 3 and 4. The system delivers the created eForm to the appropriate application, placing the eForm into a database, e-mailing the eForm or placing the created eForm into a particular file folder or by using whatever delivery mechanism is appropriate to the particular application.

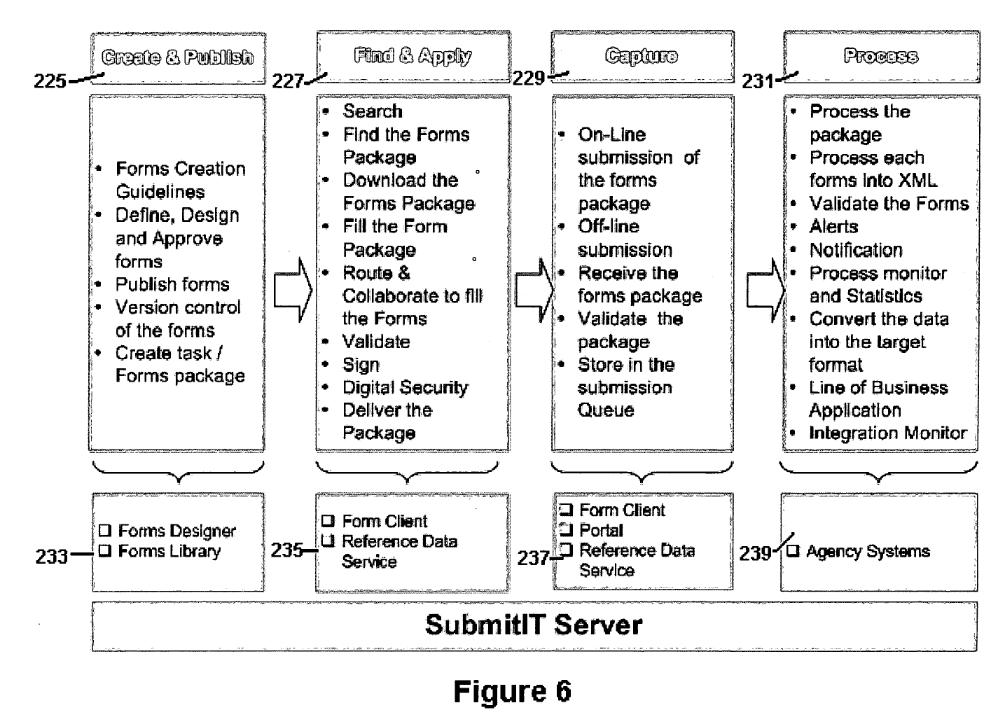

FIG. 6 is an exemplary flow diagram depicting the various stages through which an eForm (active document) may undergo from the time of its creation through its utilization. The processing operations depicted are exemplified as being performed within the server 201. However, it should be understood that the operations depicted may be embodied in client code that, for example, is added to Adobe Acrobat to perform the various functions shown (e.g., (in find and apply 227).

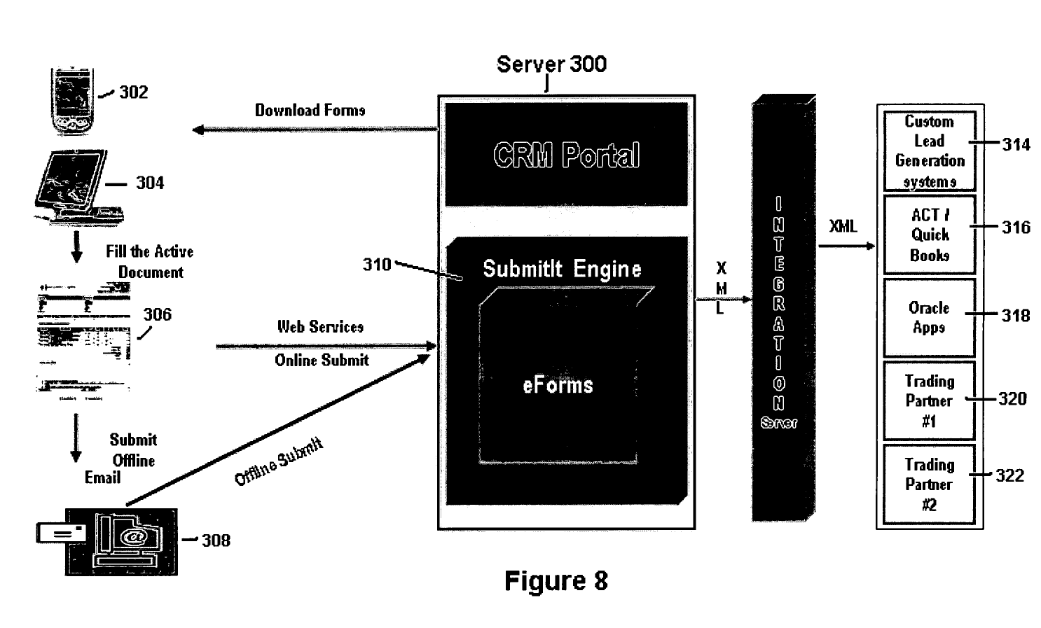

As shown in FIG. 6, and as explained above in conjunction with FIG. 5, the lifecycle of an eForm begins with its creation and publishing (225). An eForm is created using form creation guidelines in accordance with, for example, the server 201's “forms designer” utility and “forms library” (233). As explained above in conjunction with FIG. 5, the eForm creation process involves defining and designing a form based on, for example, an input PDF document. The creation and publishing step 225 may, in an exemplary embodiment, result in the approval of a form by, for example, routing the form to a form approval entity. The publishing of forms involves the process shown and described above in conjunction with FIG. 5 including selectively inserting active elements such as Java script into, for example, a PDF file. The processed, active document-based form may then be stored in a file which is accessible by others, for example, the CRM Portal 300 in FIG. 8, described below.

The create and publish processing operates to ensure version control of forms to keep track of changes that have been made in a modified form. The create and publish function also involves creating a task/forms package in which forms are stored in a repository. The forms packaging process involves inserting one or more forms into selected portions of a document to create the forms package.

With respect to the “find and apply” 227 portion of an eForms lifecycle, a user may, for example, connect to a web portal to search for and find a particular form package. The user may then download the forms package to, for example, the user's laptop computer, tablet computer, smart phone or PDA or home PC. The user, after downloading the forms package, may then subsequently fill in the form package, either upon receipt or at any subsequent time convenient to the user. It should be understood that the downloading operation may be performed via e-mail, where the forms package will be e-mailed to a requesting user, alternatively, the forms package may be downloadable directly from a customer's website. The forms package may even, for example, be received by a user by receipt of a CD through the mail.

In accordance with an exemplary embodiment of the present invention, under circumstances where a user does not have sufficient information to complete all of a form, after portions of the form are filled in by the user, a form portion is routed to a further site for collaboration in completing the form. In this fashion, a collaborator (e.g., a business partner having different product responsibilities than the original user) may provide information not available to the user who downloaded the forms package. Alternatively, in other applications, the routing and collaboration may involve the approval process for a purchase order to enable an electronic purchase to be completed.

The find and apply processing 227 may also involve validating data in light of rules which may, for example, be application dependent. In electronic commerce and other applications, the eForm may be digitally signed and other digital security measures may be incorporated to employ authorization and verification cryptographic operations.

The routing and collaborating processing may employ the enhanced digital signature methodology disclosed in U.S. Pat. No. 5,214,702, which provides for a wide range of collaborative digital signatures, including counter signatures and is hereby incorporated by reference in its entirety. Using the methodology described in U.S. Pat. No. 5,214,702, a submitted forms package may be routed through various layers of authorization. Using this technology, the person who signed the particular form package may be proven to have had the authorization necessary for a given application, such as an electronic commerce transaction, to be completed. Collaboration may also involve including a notification package receipt indicating success/failure and resubmission requests. Further, the collaboration may involve in the case of government grants, an indication of status changes in an application as, for example, the application goes through one of multiple steps involved in the application processing.

The forms package is thereafter delivered in the find and apply processing via either on-line or off-line methodologies. As an alternative, the package may be delivered via fax to fax server 72 (FIG. 3).

With respect to filling in the form package, if the form is a PDF file, the process of filling in the form may utilize, for example, Adobe Acrobat Reader, together with “form client” and “reference data service” utilities provided at 235.

The reference data service permits the client to utilize the SubmitIT server 201 to retrieve reference data related to a particular forms package. For example, if the forms package involves ordering parts, the reference data service and the server 201 may be used to supply a list of valid part numbers.

The capture processing 229 occurs at the server 201 after a client has performed the find and apply processing 227. After the client has submitted a completed form, the form is received at the server side. The form will either have been submitted via an on-line submission of the forms package via web services or, for example, by an off-line submission via e-mail. Additionally, the form may be printed out and faxed to the server 201. The received fax would then be scanned and processed as explained above in conjunction with FIG. 3. The forms package is received and validated by the server and stored in a submission queue.

The server 201, as indicated at block 237, has associated various utilities for use in capture processing. Form client software is used during submission processing to enable the client to submit the form. The portal services permits the capture of the form via web services. The reference data service is utilized during the capture processing 239 to provide access to business rules, validation rules, and to perform field level data validation beyond that performed in the find and apply step 227.

The design of the eForms-based system is intended to accommodate a wide range of communications media. For example, during capture processing 229, the system supports multiple transport protocols such as web services, HTTP(s), FTP, SMTP, WiFi (802.11), paper and fax, which may be utilized to capture a forms package. The system is intended to support a wide range of eForm vendors and technologies. During the capture processing, security may be enhanced by utilizing a digital notary so that it is possible to unambiguously establish the date and/or time of submission.

The server 201 performs a series of processing operations on the forms package (231). The form is received and processed by, for example, converting the form into XML (as explained above in conjunction with FIG. 3 and in the above-identified co-pending incorporated application) in accordance with the rules that were established when the form was created. Conversion processing will involve converting the data into a target format which may, for example, be XML, depending upon what the line of business application requires. The forms are validated during the processing 231 to validate the data that was filled in by the user. The validation performed will vary depending upon the particular application. If the validation fails, alerts are generated to, for example, indicate various error conditions. Various notifications are generated to indicate, for example, that a forms package has been received and/or has been processed.

The server 201, in an exemplary implementation, keeps track of form packages which have been received and maintains statistics indicative of, for example, how many form packages have been received, how many have been processed, etc., as has been described in conjunction with the above-identified incorporated application.

In accordance with an exemplary embodiment, the data may be converted into a neutral format, such as XML and then further converted into a line of business application format. The data then will be delivered to the line of business application.

During eForm processing 231, in order to properly validate a form, data may be fetched from a common data registry to receive financial information from, for example, a Dunn & Bradstreet data registry. The processing 231 supports the full submission of forms, a partial submission of forms, the resubmission and the partial resubmission of such forms. An integration monitor may be used to support multiple delivery protocols for delivering any forms package via web services, HTTP(s), FTP, SMTP, or supporting specific client requests.

If the line of business application is, for example, a government application, the server 201 utilizes agency systems software (239) to complete the processing.

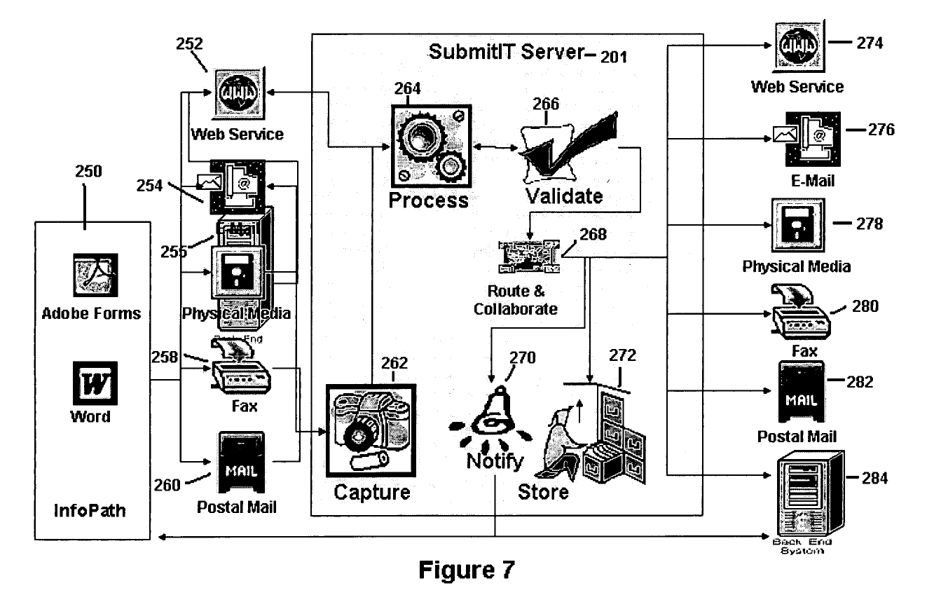

FIG. 7 is a block diagram showing the server architecture and associated input and output receipt and distribution. As pictorially represented at 250, a form may initially be received as an adobe PDF format document, a Word document or an XML-based InfoPath document. Documents of these and other forms are input to the SubmitIt server 201 and are converted to active documents as described above.

The documents may, for example, be submitted to the server 201 via web services 252 or via e-mail 254. Alternatively, the document may be input via a physical media such as, for example, a floppy or a CD, which in turn is transmitted by physically transporting the media to server 201. A document also may be forwarded to a server via facsimile 258 or via postal mail 260. If the document is received via facsimile, then it is processed in server 201 via the capture processing (262) which was explained in detail in conjunction with the FIG. 3 fax 74, fax server 72 and in the above-identified incorporated co-pending application.

Whether the information is received via facsimile and processed at 262 or via some other mechanism such as web services 252, the server 201 processes a form at 264 as, for example, explained above in conjunction with the FIG. 6 processing step 231. The form is then validated in the server at 266, after which it is routed to destinations if collaboration is required (268) and distributed to the line of business application either via web service 274, e-mail 276, physical media 278, fax 280, postal mail 282 or to a back end system 284. The back end system is, for example, the line of business application.

The data which is being routed may be stored within the server (272). Storage of the data at 272 may not occur in certain applications, where, for example, the data need not be referenced again. Additionally, various notifications are distributed to either the back end system 284 or the client who submitted the input form document.

A server 201 having the above-described functionality may be utilized in a wide variety of applications, including customer relationship management (CRM) applications. Thus, one application of the above-described active document methodology may be in managing customer support, responding to customer problems and managing data related thereto.

FIG. 8 is a block diagram that illustrates a system for applying the active document methodology described above in a customer relations management application. The server 300 stores a variety of packages of eForms. A PDA 302, PC 304, a tablet computer (not shown), smart phone (not shown) or a laptop (not shown) may be utilized by a user to access server 300 and download a selected form/forms package. Once downloaded, the user fills in the active form. The active form would include the previously described active elements and, for example, may include embedded questionnaires and associated validation mechanisms. Thus, the program code-based intelligence including the routing/mobilizing software is embedded in document 306. After the form is filled out by the user, the form is submitted either via an on-line submit, for example, via web services or an off-line submit via e-mail 308.

The received active form is processed by the SubmitIt engine 310 having the eForms processing package described above in conjunction with FIGS. 6 and 7. The SubmitIt engine 310 produces, for example, an XML electronic document (or other format suitable for the given line of business application) which is coupled to an integration server 312. Integration server 312 may be, for example, a BizTalk server which then converts the data to the form required by the given line of business. The server 312 supports multiple delivery protocols like web services, HTTP(s), FTP, SMTP, etc.

The data is then customized to the given application for use by a custom lead generation system 314, which is described in detail below. Alternatively, the document for example, in XML form, may be routed to an ACT application 316, which is, for example, a contact management system for contacting customers and includes customer names, addresses, etc. or Quickbooks 316 which is an accounting system. The information may be routed to an Oracle database application 318. Alternatively, the information may be routed to any number of different trading partners as represented at 320 and 322.

Thus, the active form mobile software architecture described above permits wide flexibility in terms of connectivity. Data is permitted to enter the system via a wide range of input mechanisms including e-mail, facsimile, Web services, etc., and incorporates the ability to work with any document type, including PDF, Word, InfoPath, and others. Likewise, the system's output envisions via the same wide range of connection mechanisms.

Lead Generation Server Application

As shown in FIG. 8, a custom lead generation system 314 is contemplated as one of many potential applications for the active document/mobile software methodology described above. The following is a description of an illustrative lead generation server implementation.

Enterprises are spending significant sums in marketing their products and services by conducting events and publishing white papers and related marketing collateral on their products and services. The linkage between this activity and lead generation is loose at best.

The process of generating/capturing high-quality leads that can be taken through the complete sales cycle is still very complex, and in many cases a hit-or-miss effort. There is constant tension between the marketing organization, whose primary role is to generate sales leads, and the sales organization, whose primary role is to convert these generated leads into closed sales. Marketing departments typically measure the degree of success in their mission by the quantity of leads they generate, irrespective of the quality of these leads. Sales organizations on the other hand measure their success on booked/collected revenue, which is directly tied to high-quality, high-interest leads.

The gap between the leads that marketing is “tossing over the wall” and the leads that sales really needs can be bridged if marketing organizations execute marketing programs that allow them to generate, and more importantly, identify high-quality leads.

One existing method of capturing high-quality leads is through the process of getting feedback or inquiries from customers who read or review marketing documents. The fact that a reader has taken the trouble of “self selecting” themselves in responding, indicates a high degree of interest, which in turn is a strong indicator of a high-quality lead. Many companies currently conduct on-line surveys. The survey respondent has to login to a web site or post an e-mail to communicate his opinion or feedback. Online surveys have not been shown to be a very effective way to generate “publication driven” leads since most publications are distributed in PDF format that allows offline reading while the surveys are conducted online. Because of this gap, most readers lose interest in filling out the feedback surveys.

The marketing agencies or the marketing department within the enterprises runs various campaigns and surveys to collect information from the target users. These surveys may be online web based or through electronic forms such as PDF, Word, InfoPath forms or paper based. The inventors recognize that “lead” information needs to be captured and routed for action to people within the enterprise or the appropriate lead Partners for action. The information needs to be analyzed and preferably presented by charts or graphs. These lead data also need to be integrated with multiple third party applications such as CRM, Contact Management, Business Intelligence, Statistical Analysis and Lead Management applications.

The marketing documents are mostly available as PDF documents. These documents are passive documents.

The exemplary embodiments described below collect vital lead information from the reader of these documents by way of survey forms attached to these static marketing documents. This lead data captured and gathered from the user may also be used as a metric to measure the success of the various marketing campaigns and also help close the loop between marketing and sales by integrating the lead data with the CRM applications.

Each marketing agency and enterprise in accordance with the exemplary embodiment is able to capture the leads for multiple partners/clients or departments within an enterprise and also run multiple projects/programs for a partner/client or department. A flexible multi-line organization structure is provided for aggregating this lead information. The partners/clients or departments are able to view the lead data organized by projects or programs.

An exemplary embodiment of the lead generation system provides a comprehensive solution for the capture, analysis and processing of lead data submitted via online/offline, electronic and paper based forms that are embedded in marketing collateral, surveys or related documents.

The rich clients for the exemplary lead generation system will be content generation applications such as Front Page, Adobe Acrobate Reader, and Word where the marketing content is generated. The exemplary lead generation system client plug-ins will be embedded within these content generation applications to ease the process of designing and generating the appropriate survey forms, attaching these to the marketing collateral, and mobile-enabling these documents for distribution as Lead Generation Marketing Collateral.

This collateral or documentation can be distributed either manually, through a lead generation system portal for download or mass distribution using the distribution lists by email or fax through the lead generation server.

Platform Functional Overview

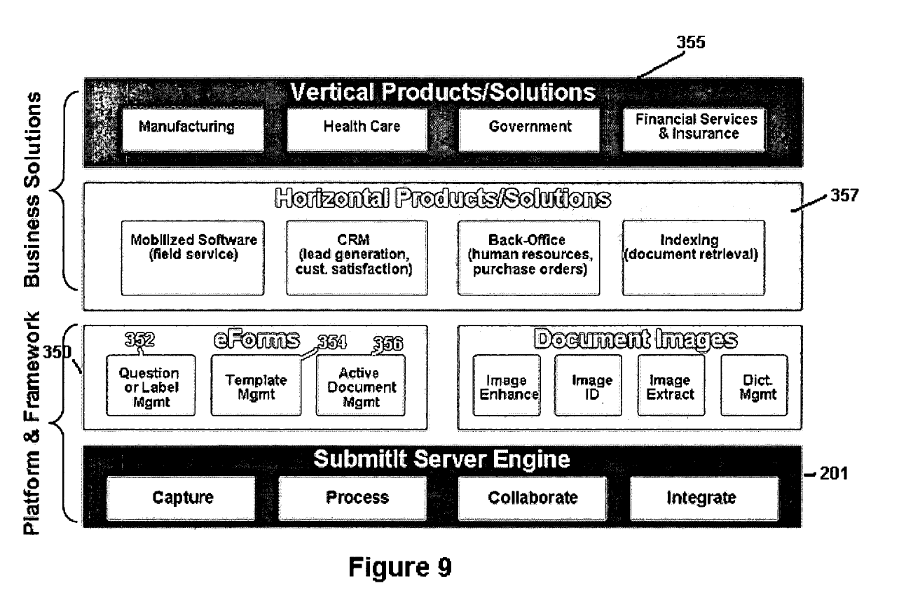

FIG. 9 is a block diagram showing an illustrative lead generation system's eForms platform, framework and business solution. The Lead Generation Server 201 is built on the SubmitIt/eForms platform which has been described above. The capture, process, collaborate and integrate operations have been explained above in conjunction with FIGS. 5 through 8. The platform shown may be utilized for lead generation and/or other active document applications such as is represented by the vertical products/solutions 355 across a wide range of industries (with exemplary applications in manufacturing, health care, government and financial services and insurance applications) and horizontal products/solutions 357 within a corporate entity (with exemplary applications in mobilized software (e.g., for field service), CRM (lead generation, customer satisfaction monitoring), back-office applications (human resources, purchase orders) and indexing (document retrieval)).

The server 201 interacts with eForms subsystem 350 and document image processing subsystem 356. The eForms subsystem 350 includes a question or label management system 352, a template management system 354 and an active document management system 356.

The question or label management system 352 is responsible for creating and maintaining a set of questions used to obtain feedback from the recipients. Questions are synonymous with the ‘label’ or ‘prompt’ accompanying a response area. This set of questions will be maintained in a questionnaire library for reuse. The questionnaire management subsystem 352 is operable to create a new questionnaire or to enable a user to select one or more questionnaires as will be explained further below. The system is operable to add, delete or modify one or more questions and publish a questionnaire. The published questionnaire is then stored in a questionnaire storage library so that one or more questionnaires may be selected for use.

The template management subsystem 354 relates to a survey questionnaire that has a predefined set of questions is a specific format and style. A list of standard templates will be available in the server 201. The template management system will permit the selection of questionnaires from a questionnaire library and a selection of themes from a theme library. The subsystem will permit users to create, modify or delete templates and to publish a generated template and store the template in a template library from which users may select a template for use.

Active document management subsystem 356 permits a user to manage a document that has an embedded survey form attached to it, in order to obtain feedback from readers of the document. The reader feedback can be captured online or offline and routed to the appropriate departments or business partner's. The document can capture feedback from any number of users who read the document. The active document management system will permit, for example, selecting a marketing document, selecting a template, and selecting a marketing program for generating an active document. The generated active document will be published and stored in an active document library. The generation of active documents permits the selection and updating of routing rules for the active document, and will include mobile software for distribution as required by a given application. The active documents will be distributed through an active document distribution management module through configured channels such as e-mail or fax to the target audience based on a distribution list. The distribution of an active document permits the selection of both an active document and a distribution channel. A distribution channel may, for example, include e-mail or facsimile. Users of the active document distribution management module will be able to select a distribution list and update the distribution list. For each generation system, in accordance with an exemplary embodiment, will also include an organization management module which initially installs a default or home organization. Users can be mapped to this home organization who can then set up partner organizations and partner users. The home organization users can create roles and privileges. The home organization users administer the other modules in the system. Suborganizations or departments can be created under the home organization. These suborganizations are not visible to one another. Each of these suborganizations may be strategic business units inside an organization.

In accordance with an exemplary embodiment, various additional modules are used in the lead generation system which are described below. For example, the lead generation system in accordance with such an embodiment utilizes a partner management module. A partner is an organization that subscribes and uses the lead generation server to publish documents related to its products, collect feedback and generate leads. For example, a marketing company might create a partner organization for each of the marketing companies clients. Each such client would only be able to interact with their portion of the system.

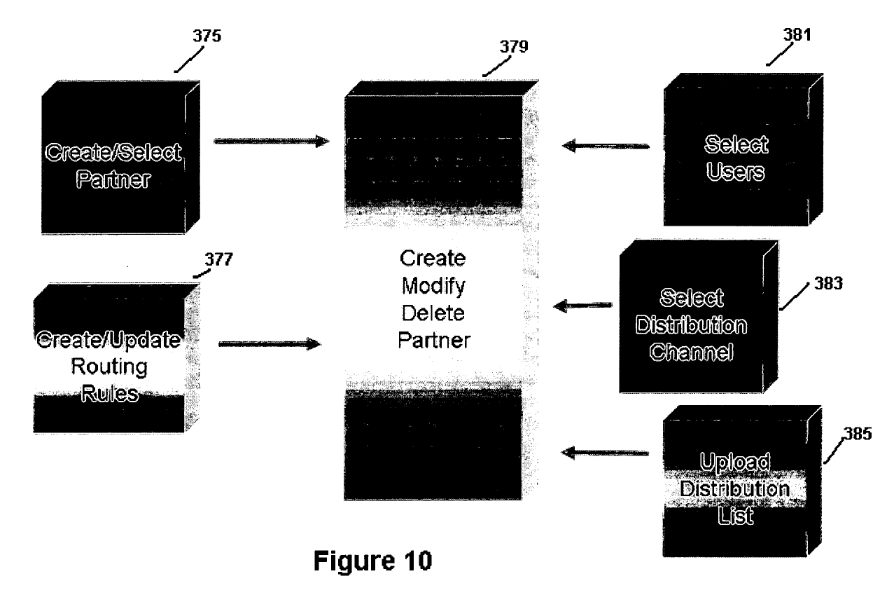

FIG. 10 is a block diagram which shows the basic operations performed by the partner management module. The partner management module 379 is operable to create, modify or delete partners. The partner management module may be used to create or select a partner (375), and to create or update routing rules (377). Users may be selected (381) by the partner management module. Distribution channels may likewise be selected (383) and distribution lists may be uploaded (385) by the partner management module.

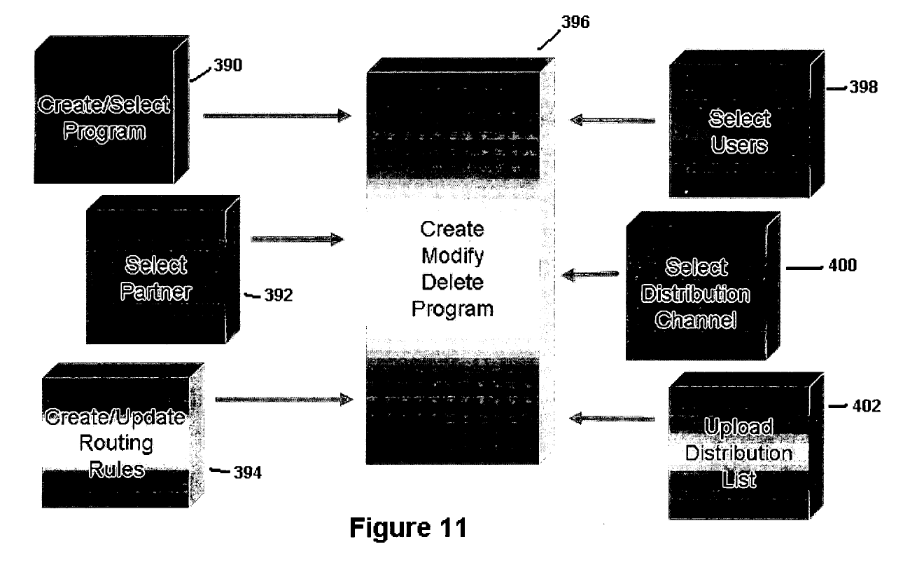

FIG. 11 is a block diagram which shows the basic operations performed by a program management module. Programs are areas of interest/subscription units for which a partner wants to generate leads. For example: Intel has a number of products in its product line. In order to popularize and market its latest chip ‘Centrino’ that supports mobility, it conducts a program called ‘mobility program’. All white papers published for this product will fall under the ‘mobility program’. The program management module is operable to create or select a program (390), select a partner (392), create or update routing rules (394), select users (398), select a distribution channel (400) and upload a distribution list (402). The program management system is operable to create, modify or delete a program (396).

In an illustrative embodiment, the program management module is operable to perform the following functions.

PRM-02 1) Map Program to Partners

A partner user or home user is able to map the Program to multiple Partners. This may be the case for joint marketing program where more than one Partner is involved.

PRM-03 2) Map Program to Partner Users

A home user or partner user with appropriate privileges is able to map partner user or set of partner users to a Program. By default all the users of the Partners who are mapped to the program will be displayed. The partner user will be able to perform the following functions based on the privileges:
1. View the list of Programs associated with the Partner to which the user belongs.
2. View all the leads by Programs to which the partner user is associated
3. Add/modify/delete users to the programs
4. Map routing rules to the Programs
5. Add/Edit/Delete routing rules
6.
   PRM-04 3) Map to Program Home Users

A home user with the appropriate privileges will be able to map home user or set of home users to a Program

PRM-05 4) Map Program to Sub Organization

A home user with appropriate privileges will be able to map Program or set of Programs to the sub organization

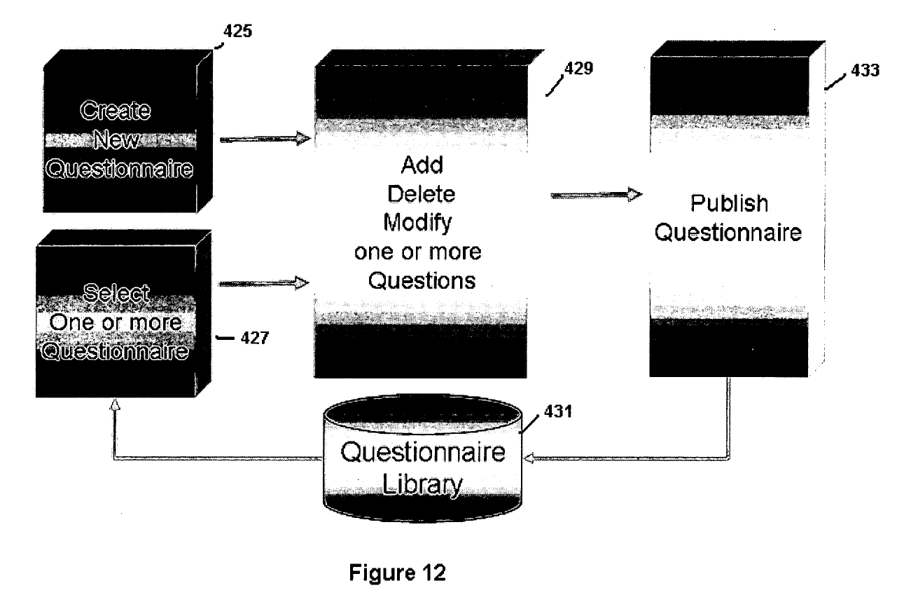

FIG. 12 is a block diagram depicting the operations performed by the questionnaire management subsystem 352. As shown in FIG. 12, the questionnaire management system operates to create a new questionnaire (425) or select one or more questionnaires (427). A questionnaire contains a set of questions used to obtain feedback from recipients. The questionnaire management module is operable to add, delete or modify one or more questions for such questionnaires (429). A questionnaire once created may be published (433) as will be explained further below, and stored in a questionnaire library (431). The questionnaire library may be accessed for selection of one or more questionnaires for subsequent use.

In an illustrative embodiment, the above-described questionnaire management module 352 is capable of performing the following functions:

QRM-01 1) Questionnaire Category

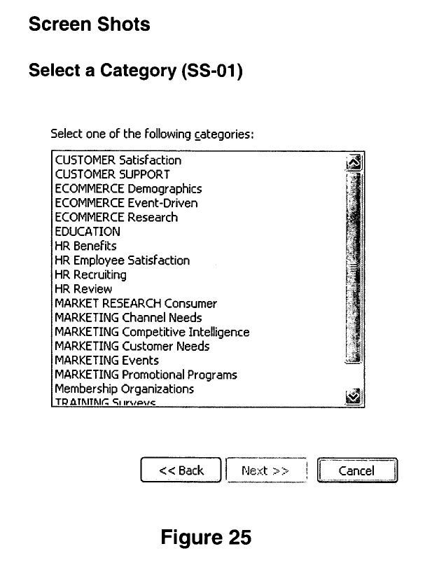

A home user will be able to select/add/modify/delete Questionnaire category for easy administration and retrieval of Questionnaires. Every Questionnaire will belong to one or more Questionnaire Category. During the process of creating a questionnaire a user will be required to specify the category the questionnaire belongs to, as shown in the exemplary screen display shown in FIG. 25 (screen shot SS-01).

QRM-02 3) Define New Questions

A partner user or enterprise user with appropriate privileges will be able to define new questions for a given questionnaire using the Questionnaire Management module. For each question,
Able to specify a question type along with meta data, such as, question text and response text as applicable (see QRM-11 to QRM-19, etc.)
Specify listing order of question based on number of questions currently in the questionnaire
   QRM-03 3) Modify Existing Questions

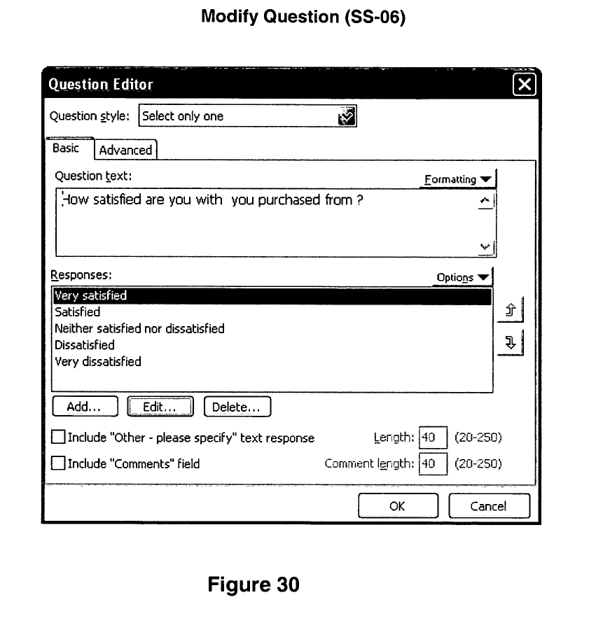

A partner user or enterprise user with appropriate privileges will be able to modify the existing questions in a given questionnaire using the Questionnaire Management module. For each question,
Able to modify the meta data, such as, question text and response text as applicable (see QRM11, etc.)
Modify listing order of question based on number of questions currently in the questionnaire
A user will not be able to modify the structure of the question such as adding one more option in a drop down menu.
After each question is modified, the question list will be displayed to allow user to select another question to change or conclude the change process as shown in the exemplary FIG. 30 screen display (screen shot SS-06).
   QRM-04 4) Delete Existing Questions

A partner user or enterprise user with appropriate privileges will be able to delete existing questions from an existing questionnaire as shown in the exemplary FIG. 30 screen display (screen shot SS-06)

QRM-05 5) Add Routing Rules to Question

A partner user or a home user with appropriate privileges will be able to add routing rules to each Question

QRM-06 6) Add Routing Rules to the Questionnaire

A partner user or home user with appropriate privileges will be able to add routing rules to the Questionnaire

QRM-07 7) Map Questionnaire to Partner

A partner user or home user will be able to map a Questionnaire to a Partner or set of Partners

QRM-08 8) Map Questionnaire to Program

A partner user or home user will be able to map a Questionnaire to a Partner or set of Partners

QRM-09 9) Map Questionnaire to Sub Organization

A home user will be able to map a Questionnaire to a sub organization or set of sub organizations

QRM-10 10) Spell Check

A spell checker routine will check the spellings of the common words based on a dictionary. The spell checker can be invoked during the process of adding or modifying questions (QRM-02 and QRM-03)

QRM-11 Pick One

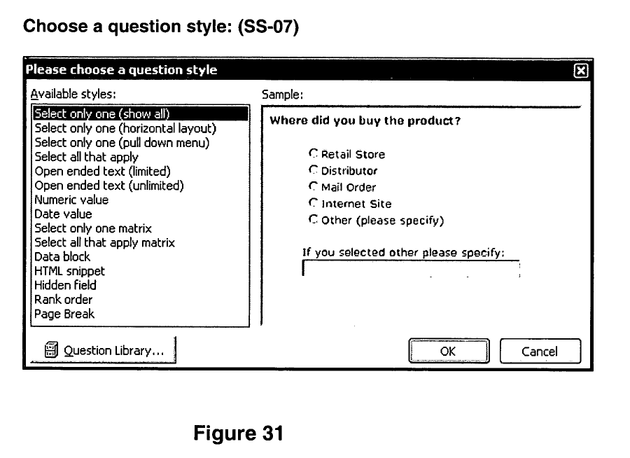

This response option will define the possible options and the reader of this survey will be able pick and choose only one answer options as shown in the illustrative FIG. 31 screen display (screen shot SS-07).

QRM-12 Check All That Apply

This response option will define the possible options and the reader of this survey will be able to select one or more of the options as shown in the illustrative FIG. 31 screen display (screen shot SS-07).

QRM-13 Rank Along Scale

This is a comparative satisfaction scale used to measure the reader's satisfaction/dissatisfaction for a given problem. This is a user-friendly reader response in a scale of ‘1’ to ‘5’ for example. ‘1’ may mean very dissatisfied and ‘5’ may mean very satisfied. The reader will choose any one between ‘1’ and ‘5’. The reader has an option to select only one. See FIG. 31 (screen shot SS-07)

QRM-14 Dropdown Box

This is an option for the reader to select only one of the pre-defined options from a dropdown list box. See FIG. 31 (screen shot SS-07)

QRM-15 List Box

This is an option for the reader to select one or more based on the list which can be seen all or some based on the size of the list box. The list box can be scrolled vertically or horizontally to see all the choices available by the reader. See FIG. 31 (screen shot SS-07)

QRM-16 Single Line Text Response

This is text box with only one line. There is no multiline capability. The length of the characters is fixed to the display length of the text box. See FIG. 31 (screen shot SS-07)

QRM-17 Multiline Text Response

This is a text box with the capability to input more than one line. This is used in the scenario where the reader needs to give a free flow response. See FIG. 31 (screen shot SS-07)

QRM-18 Numeric Allocation

This is a reader's suggested allocation of a predefined number may be 100 or 10 or any pre-set number. There is a list of options with a numeric box next to it. The reader will assign the appropriate number and the sum will always add up to the pre-set number. This is used to get an idea of the allocation of time or in case of a product feature list the weightage of each to the end user. See FIG. 31 (screen shot SS-07)

QRM-19 Matrix

This option is used when response needs to be based on a row and column questions. There will be only one option to be selected on each row. See FIG. 31 (screen shot SS-07) QRM-20 Must answer

This answer option ensures that the reader responds to this question without fail. The user will not be able to submit the survey without completing this question. See FIG. 31 (screen shot SS-07)

QRM-21 Copy Questions from Existing Questionnaire

A new questionnaire can be developed by coping all or part of questions from one or more than one questionnaires

QRM-22 Display Horizontally

This option will design the answer options to be displayed horizontally

QRM-23 Display Vertically

This option will design the answer options to be displayed horizontally

QRM-24 Response Validation

This option will be useful when the user responses need to be validated such as date validation, numeric validation etc

QRM-25 Table

This option will be useful when the user needs to collect multiple rowset of responses. The number of rows may be pre-defined or unlimited. The columns are predefined and responses for each row are collected in unique cells. The response for each cell will be mapped uniquely to a row and column. These cell responses will be textboxes, select one, select all, combo box, etc.

QRM-26 Select Yes/NO

This option is used when the user needs to get yes or no response from the reader.

QRM-27 Display Questions in Questionnaire

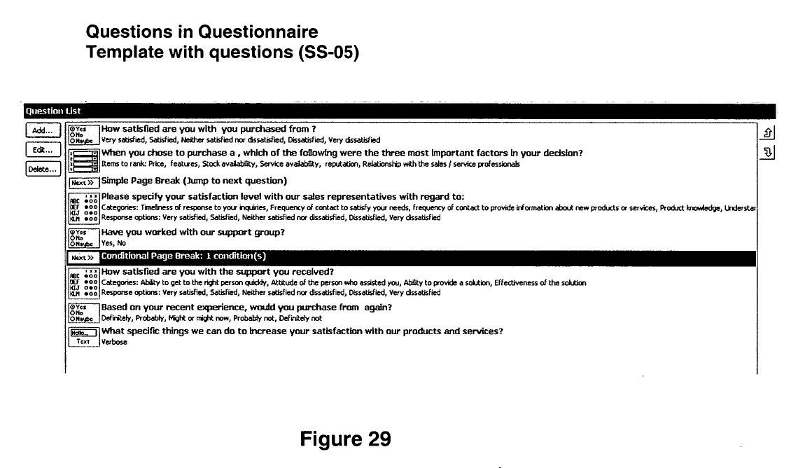

The Questionnaire with the added or modified questions will be displayed to the user to verify for accuracy. The user will be able to navigate and select the individual questions for modification or deletion. See FIG. 29 (screen shot SS-05)

QRM-28 Capture Questionnaire Name

This is the user given name for the Questionnaire. The user will change this name in future.

QRM-29 Generate and Save Questionnaire

The questionnaire will be saved locally on the users system. The Questionnaire will be saved on the default location for the questionnaire.

QRM-30 Store Questionnaire on Server

The completed questionnaire after saving locally will be stored on the Server. The LGS Questionnaire Management web service will be invoked by the LGS client plugin to save the Questionnaire on the Server

QRM-31 Select Questionnaire

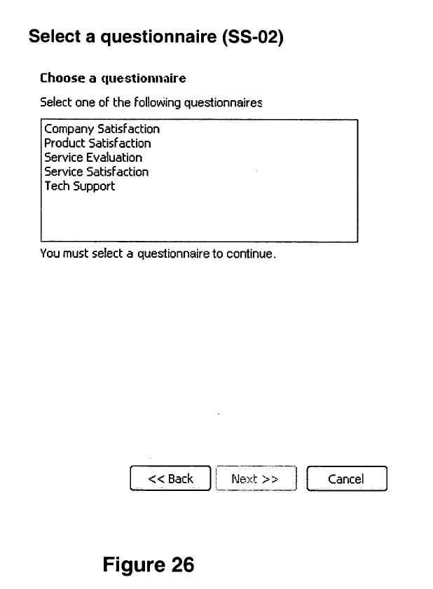

The list of available Questionnaire will be displayed to the user for easy selection of the Questionnaire. The LGS client plugin will invoke the LGS Questionnaire Mgmt webservice to retrieve a list of the available Questionnaires. See FIG. 26 (screen shot SS-02)

QRM-32 Select Question

Any question on the Questionnaire will be able to be selected for editing or deletion.

The question list will be displayed to the user. See FIG. 26 (screen shot SS-02)

QRM-33 Modify Questionnaire Name

The Questionnaire Name may be changed by the user if need be.

QRM-34 Generate and Save Modified Questionnaire

The modified Questionnaire will be saved on the user's local system in the default directory. The user should however be prompted for the location to save the questionnaire.

QRM-35 Store Modified Questionnaire on Server

The modified Questionnaire will be stored on the Server. The LGS client plugin will invoke the LGS Questionnaire Mgmt web service to save the modification.

QRM-36 Delete Questionnaire

The selected Questionnaire will be deleted from LGS. The client plugin will invoke the LGS Questionnaire Mgmt web service to delete the Questionnaire.

For an example of an illustrative questionnaire management system, see the website www.websurveyor.com.

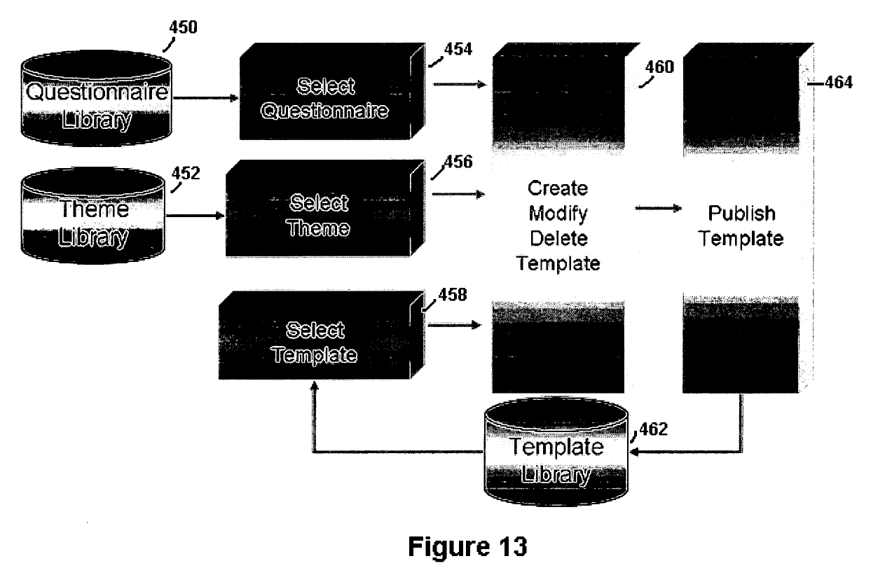

FIG. 13 is a block diagram illustrating the operations performed by the template management module (354). A template is a survey questionnaire that has a predefined set of questions in a specific format and style in, for example, a PDF document. A list of Standard templates will be available in the Lead Generation Server. As shown in FIG. 13, the template management system is operable to access a questionnaire from a questionnaire library (450), and to select a questionnaire contained therein (454). Additionally, the template management module has access to a theme library (452), and is operable to select a theme therefrom (456). The template management module is operable to create, modify and/or delete a template (460), and to thereafter publish the template (464), as will be described further below. The published template is then stored in a template library (462), which is accessible for template selection (458).

In an illustrative embodiment, the template management module 354 is operable to perform the following functions:

TPM-02 Template Category

All templates will belong to a previously defined Questionnaire category for now.

(see QRM-01)

TPM-03 Add New Templates

A partner user or enterprise user with appropriate privileges will be able to define new templates using the Template Management module

TPM-04 Modify Existing Templates

A partner user or enterprise user with appropriate privileges will be able to modify an existing Template using the Template Management module in the adobe plug-in
The existing template library can be browsed and an existing template can be selected for updating
The existing Questionnaire library can then be browsed and set of questions from multiple Questionnaires can be copied to the template
Existing questions in template can be deleted as well
   TPM-05 Delete Existing Templates

A partner user or enterprise user with appropriate privileges will be able to delete existing template using the Template Management module

TPM-06 Add Routing Rules to Templates

A partner user or a home user with appropriate privileges will be able to add routing rules to the template.

TPM-07 Map Templates to Partner

A partner user or home user will be able to map a Template to a Partner or set of Partners

TPM-08 Map Templates to Program

A partner user or home user will be able to map a Template to a Program or set of Programs

TPM-09 Design from Scratch

A template can be designed from scratch.
One of available template styles can first be selected (a style will be a layout consisting of locations for logo, header text and footer text)
The existing Questionnaire library can then be browsed and set of questions from the selected Questionnaires can be copied to the template. For this version iterating through multiple Questionnaires is not supported.
Existing questions in template can be deleted as well

TPM-10 Copy from existing template (this might be similar to TPM-04)

A template can be copied from an existing template. All the questions and design elements of the template are editable A new set of questions can be defined. An existing set of questions can be deleted

TPM-11 Use Logo

The user will be able to insert a logo in a template per the pre-defined location in the selected template style

TPM-12 Header Text and Footer Text

The user will be able to insert header and footer text per the pre-defined locations in the selected template style

TPM-13 Title, Introduction, Closing Comments

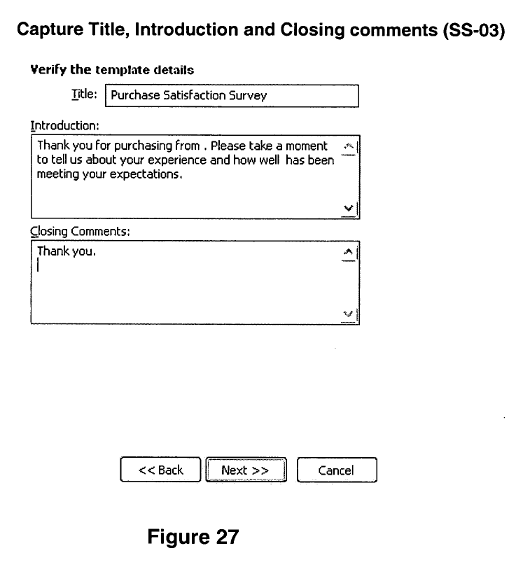

The user will be able to insert a title, introduction and closing comments in the template. See FIG. 27 (screen shot SS-03)

TPM-14 Use Pictures

The user will be able to insert a picture in a template and be able to position this in the desired location

TPM-15 Specify Key Format Items for Question Section

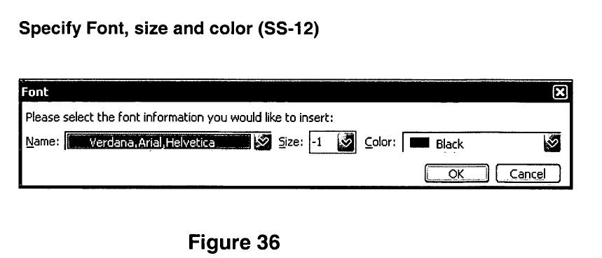

The user will be able to specify font type, font size and font color for the question section, header text and footer text. See FIG. 36 (screen shot SS-12)

TPM-16 Select Template Style

Template style is a pre-defined template with place holders for logo, header text and footer text and footer logo. The logo and text will be inserted at the time of creation of the template.

TPM-17 Create a Pre-defined Format Set

The user can define his/her format sets. A format set is a set of font, color, size or uniform set of design elements which gives a similar look and feel for the templates with the same Format Set

TPM-18 Display Template

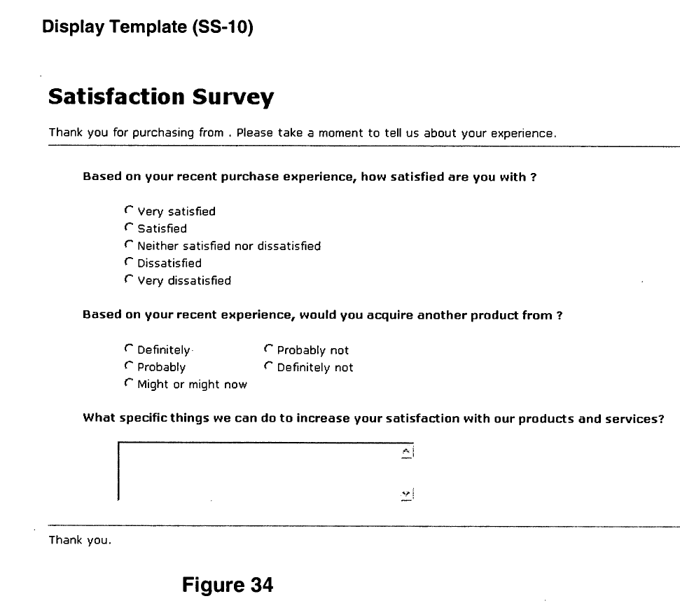

The template will be displayed as a preview to the user. See FIG. 34 (screen shot SS-10)

TPM-19 Capture Template Name

This will be user given name to the Template. This name will be changed by the user in future.

TPM-20 Generate and Save Template

The template will be saved locally on the user's computer. The template will be saved in the default location on the user's computer. However the user will be prompted with the directory location to choose for saving the template.

TPM-21 Store Template on Server

The Template will be stored on the store. The client plugin will access the LGS Template Management web service to save the template on the Server

TPM-22 Pick and Choose Questions

The user will be able to pick and choose questions as the case may be to construct the template. This may be a subset or all of the questions from the selected Questionnaire. See FIG. 29 (screen shot SS-05)

TPM-23 Select Template

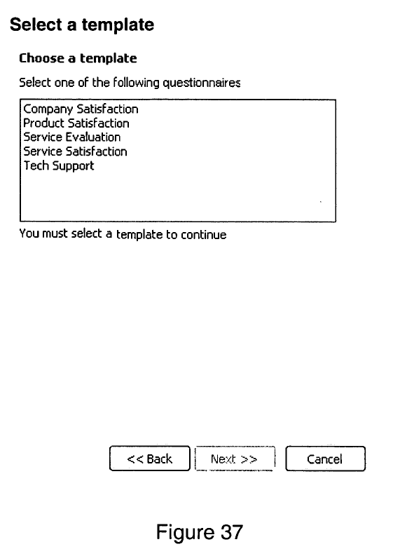

The user will be able to select the Template from the list of available templates. The list of templates will be populated by the LGS Template Mgmt webservice in response to the LGS client plugin request. See FIG. 37.

TPM-24 Specify Key Format Items for Template Style

The user will be able to specify font type, font size and font color for the Template Style, which will consist of the header text and footer text. See FIG. 36 (screen shot SS-12)

TPM-25 Modify Template Name

The user will be able to modify the Template Name. The template name can be modified any time in the future.

TPM-26 Generate and Save Modified Template

The modified template will be saved locally on the user's computer. The Template will be saved in the default location. However the user will be prompted to choose the directory location on the comptuer for saving the template.

TPM-27 Store modified Template on Server

The LGS client plugin will invoke the LGS Template Mgmt webservice to store the template on the server.

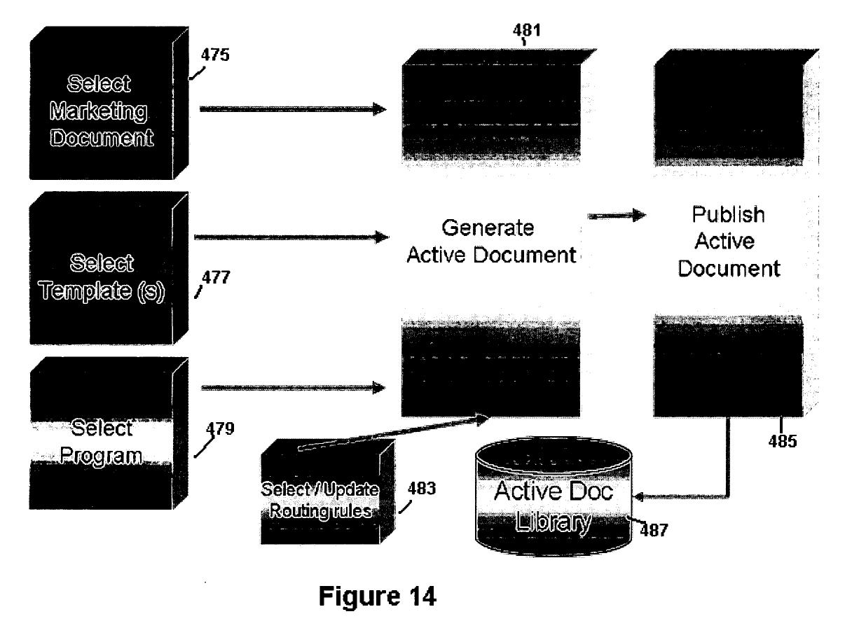

FIG. 14 is a block diagram of the active document management subsystem. In accordance with one lead generation server embodiment, an active document is a document that has a survey form attached to it in order to obtain feedback from readers of the document. The reader feedback can be captured offline/online and routed to the partner sales force. This document can capture feedback from any number of users who read the document.

As shown in FIG. 14, the active document management subsystem is operable to select a marketing document (475), select one or more templates (477) and to select a program (479). Additionally, the active document management subsystem is operable to select and/or update rules for routing the active document generated in the subsystem (483). The active document management system, based on a selected marketing document, selected template, selected program, selected routing rules, generates an active document (481) as disclosed in detail below. Thereafter, the active document is published (485) and stored in an active document library (487).

In an illustrative embodiment, the active document management module 356 is operable to perform the following functions:

ADM-03 Open Existing Document

A valid partner user in the system will be able to open an existing pdf document using the Adobe plug-in

ADM-12 Signon Templates

The Active Document author using the Active Document Management tool bar will access the predefined signon templates under the template category ‘Signon’. The selected signon template will be attached to the existing document. When the active document is opened by the reader, the Active Document will prompt the reader to provide the information in this “sign-on” form and capture the user information and display the content only after the user provides the requested information and submits the information to the Active Document Server. In case of subsequent access of the Active Document the cached information will be shown and an acceptance will be requested for sending the user information. Only on acceptance will the content be displayed to the user.

ADM-13 Reader Usage Statistics

The Active Document Management Module on the client will have this feature. The Active Document author will enable this feature. By default this feature will be off. If this feature is turned on the Active Document will capture the viewing time of the Active Document reader. The captured time will be cached and sent as part of the submission or during the closure of the Active Document.

ADM-14 Capture Comments Location Context

Capture comments anywhere on the document with location context to identity what part of the content the comments were placed on. The location context will include the relevant Page No, line no and any appropriate information

ADM-15 Context Sensitive Questionnaires

The Active Document author will be able to place on the existing static document questions or set of questions from the question library any where on the document. The Active Document author will be prompted the routing details for the question or set of questions. The Active Document author will be able to select the default routing rule or add on to the routing information. This feature will be similar to the capture comments feature in Adobe. Only a visual cue as to the existence of the questions will be available to the reader of the Active Document. When the mouse rests on this visual cue the relevant questions will be popped and the reader response will be captured.

ADM-16 Reader Response Detection

This feature will help not to lose the captured reader information by accidentally closing the Active Document. A fool proof mechanism to detect user responses in the Active Document needs to be developed. In the event of accidental closure the Active Document will popup a dialog to request the user for submission of the responses. If the user acknowledges acceptance then the captured information will be submitted to the Active Document Server. Accidental closure will be deemed when the reader of the Active Document responds to questions including comments but does not submit the responses using the action buttons of the Active Document.

ADM-17 Instant Collaboration

The Active Document will become a powerful collaborative tool between the reader and the enterprise users who are listening for the reader responses. The Active Document Management module will capture this feature. This feature will be disabled by default. If enabled the Active Document will become an instant collaborative tool enabling two-way communication between the interested reader and the enterprise user who wants to listen to the reader. The reader will see an icon in every page of the Active Document like the Instant Messenger. On clicking on this link will open a live two way communication dialog with the enterprise user. This feature is similar to live support on the web sites

ADM-10 Licensing

The client plugin will display all the Modules. Only licensed modules will be enabled and the others features will be grayed out. This will not only control the functionality in terms of packaging but also will provide significant marketing for more features.

ADM-18 Adobe Plugin Environment

In an exemplary implementation, the adobe plugin needs to available on the following versions of adobe
1. Adobe Reader 6.0
2. Adobe Designer 6.0
3. Adobe Acrobat
4. Adobe Approval

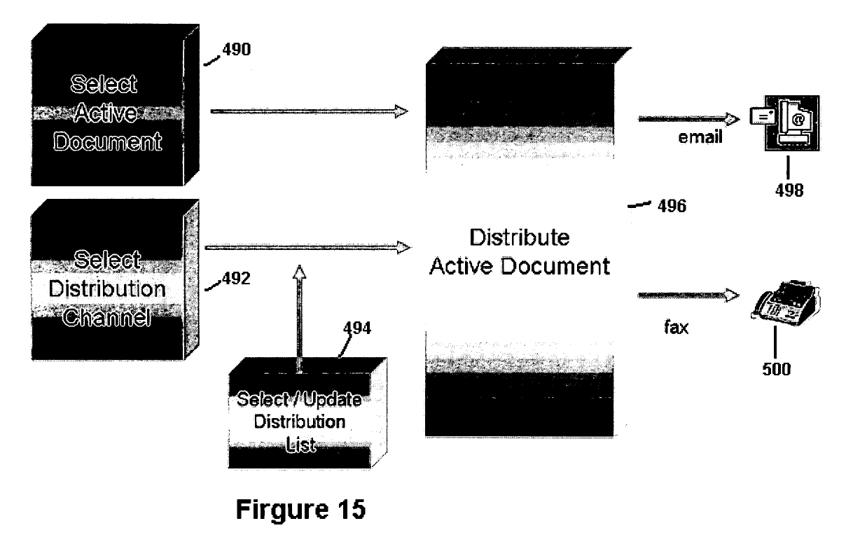

FIG. 15 is a block diagram of an active document distribution management subsystem. An active document is distributed through this subsystem through configured channels such as email or fax to the target audience based on a distribution list. As shown in FIG. 15, the active document distribution subsystem selects an active document (490), selects a distribution channel (492) and selects and/or updates a distribution list (494). Thereafter, the active document distribution management system distributes the active document (496). In accordance with an exemplary embodiment, the active document is distributed via either e-mail (498) or via facsimile transmission (500).

In an illustrative embodiment, an active document distribution management module is operable to perform the following functions.

ADD-01 Upload Distribution List

The partner user or home user with appropriate privilege will be able to upload a distribution list to the Active Document.

ADD-02 Configure Distribution Channel

The partner user or home user with appropriate privilege will be able to configure the distribution channel for distribution of Active Documents. In an illustrative embodiment, the possible distribution channels are:
1. email
2. fax
   ADD-03 Modify Distribution List

The partner user or home user with appropriate privileges will be able to modify the distribution list. They can add, modify or delete some emails in the list.

ADD-04 Delete Distribution List

The partner user or home user with appropriate privileges will be able to delete the distribution list.

ADD-05 Configure Active Document Distribution

The partner user or the home user will be able to configure the Active Document for distribution using the distribution channel specified with date and time. This is a preset date and time for mass distribution of the Active documents to the target recipients.

ADD-06 Manual Distribution of Active Document

The user using the Active Document Distribution module may send the Active document using the distribution list and the distribution channel by activating this module. This will be used for repeat distribution or manual distribution

In an illustrative embodiment, the lead capture and distribution management module is operable to perform the following functions.

LDM-01 Distribute Lead Configuration

A valid user will be able to configure the distribution frequency by partner, program and Active Document

See use case below for details

LDM-02 Track Lead

A valid user will be able to view or download leads in Excel or XML

See use case below for details

LDM-03 Download Lead Data with the Template

A valid partner user will be able to download the lead data with the template

LDM-04 Acknowledgment Notification

The system will notify the submitter based on the configuration when the Lead data is successfully received by the LGS

In an illustrative embodiment, the lead analytics and reports module is operable to perform the following functions.

LAN-01 Excel Template

There will be pre-defined templates with graphics for analyzing data using Excel.

LAN-02 Partner Transaction Summary

A partner user will be able to search and display the report. This report will be printer friendly.

The Partner Transaction Summary report will display the data in the following columns:

Heading: ‘Partner xxxxx transaction summary for the period from xxxx to xxxx’

If more than one partners are listed the Heading will read ‘Summary transaction for the period xxxx to xxxxx’

Partner Names: List the Partner names

Column titles:
1. Program Name
2. Program start date
3. Program end date
4. Leads received

The Leads will be totaled and a total lead will be displayed at the end of the report

The report will display the run date and time at the footer

LAN-03 Program Transaction Summary

A partner user will be able to search and display the report. This report will be printer friendly and based on search criteria specified.

The Partner Transaction Summary report will display the following data

Heading:

Partner Name: <Partner Name>

<Partner Name>

Program Name: <Program Name>

Transaction summary for the period from XXX to XXX′

If more than one partners are listed the Heading will read ‘Summary transaction for the period xxxx to xxxxx’

Partner Names: List the Partner names

Column titles:
1. Program Name
2. Program start date
3. Program end date
4. Leads received

The Leads will be totaled and a total lead will be displayed at the end of the report

The report will display the run date and time at the footer

In an illustrative embodiment, the security module is operable to perform the following functions.

SEC-02 Support for https Protocol

The plugin will access the LGS through web services and all the transactions will be through https protocol

In an illustrative embodiment, the licensing module is operable to perform the following functions.

LIC-01 License Key

The client plugin will be activated only after the license key generated by the LGS and sent by email is entered during plugin installation. This key will be cached and encrypted on the local system of the user

LIC-02 Client Module Activation

The client plugin will display all the Modules. Only licensed modules will be enabled and the others features will be greyed out. This will not only control the functionality in terms of packaging but also will be a powerful upsell for more features.

Others

The lead generation system in accordance with further exemplary embodiments has the following capabilities:
Grouping of documents into packages
Portal for download of individual documents or packages as required
“Offline” portal for upload of individual documents or packages as required
Partial submission and resubmission support
Auto notification of errors or missing items to the form submitter

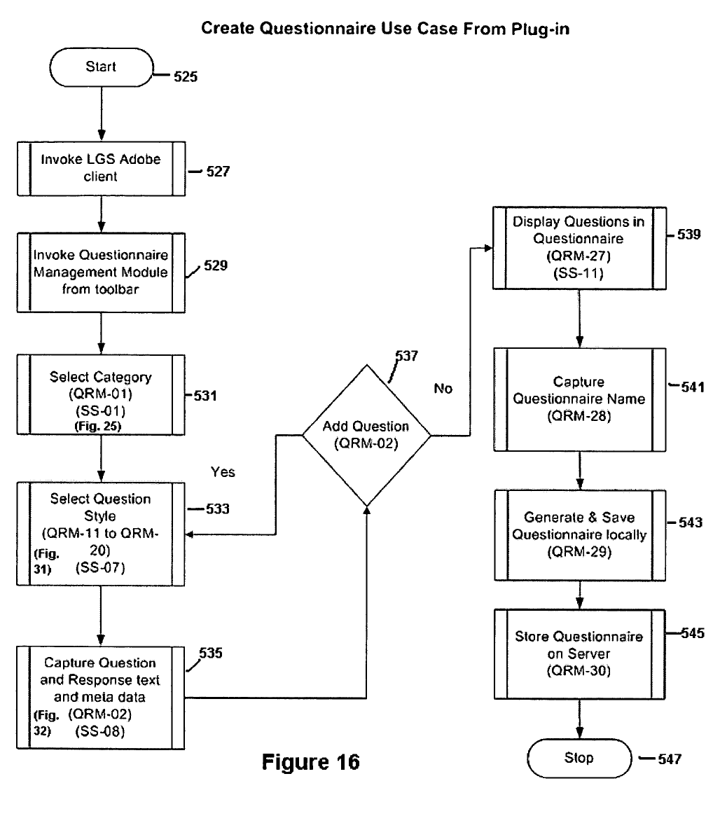

FIG. 16 is a flowchart delineating the sequence of operations involved in creating a questionnaire. Upon the start of the “create questionnaire” processing (525), the plug-in lead generation system Adobe client (which is a plug-in to Adobe Acrobat) is invoked (527). Thereafter, the questionnaire management module is invoked from the tool bar. The questionnaire management module (352) is the body of software responsible for managing questionnaire processing (529).

Thereafter, as shown on the screen display in FIG. 25, a questionnaire category is selected (531). The user may then select a questionnaire category relating, for example, to customer satisfaction, customer support, e-commerce, demographics, HR benefits, and various other categories relating to human resources (HR), marketing, etc.

After a questionnaire category is selected, a question style is selected from a menu (533). FIG. 31, for example, shows an exemplary screen display in which a question style may be selected. For example, questions may be selected to appear in a horizontal layout, in a pull down menu, or in any of the other styles shown in FIG. 31 (533). When a question style is selected and, for example, a select only one option is chosen, program code is embedded in the questionnaire to implement such a selection and to enforce the restriction that only one option may be selected.

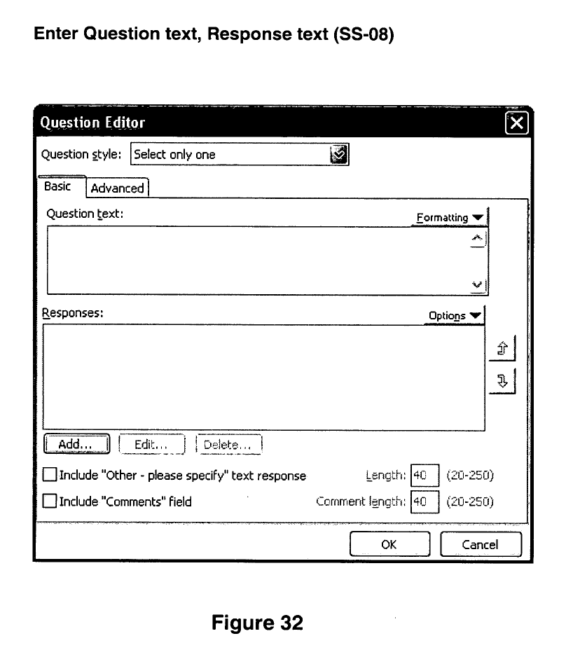

Thereafter, the questionnaire creation process permits capturing the precise question and response text and meta data (which is information/data which is descriptive of the data) (535). Meta data may include, for example, question style information. FIG. 32 shows an exemplary screen display in which fields for entry of a question text and responses text are presented. The information shown with respect to, for example, field sizes is another example of meta data which may be specified.

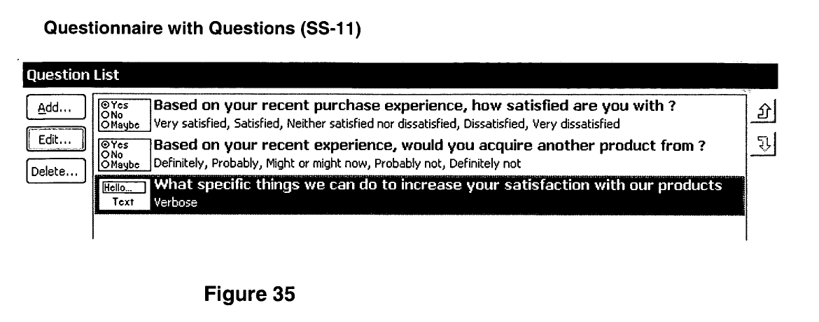

After the question response text is captured, a decision is made at block 537 as to whether an additional question is to be added. If an additional question is added, then the routine branches to 533 where a question style may be selected. If no further questions are to be added then the routine displays the questions in the questionnaire (539) as, for example, shown in FIG. 35. The displayed questions may be edited.

Thereafter, the routine will capture the questionnaire name (541) and generate and save the questionnaire locally (543). The questionnaire will then be stored on the server 201 shown in FIG. 9 and the questionnaire routine concludes (547).

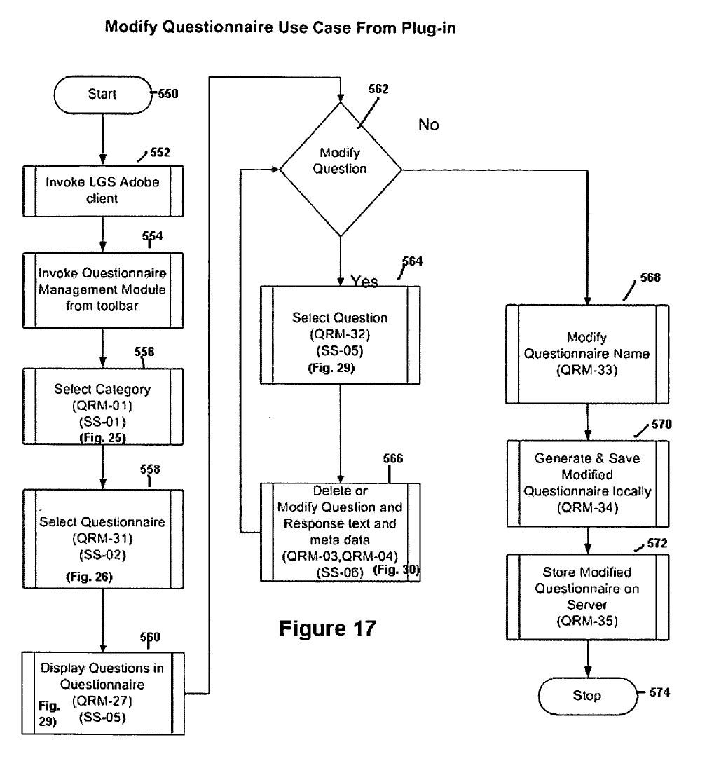

FIG. 17 is a flowchart indicating the sequence of operations involved in modifying a questionnaire. Just as set forth in the description of FIG. 16, if a questionnaire is to be modified, after the routine starts (550), the lead generation Adobe client plug-in of Adobe Acrobat is invoked (552). Thereafter, the questionnaire management module is invoked from the toolbar (554). A category of questionnaires is thereafter selected, such as is shown in the screen display of FIG. 25 (556).

As shown in the FIG. 26 screen display, a questionnaire is then selected (558) relating, for example, to company satisfaction, product satisfaction, service evaluation, service satisfaction or technical support, etc.

Thereafter, as shown in the exemplary screen display in FIG. 29, questions in the questionnaire are displayed (560), such as, for example, “How satisfied are you with—you purchase from?” The user will have the opportunity to modify this cryptic question. As can be seen from the left hand portion of FIG. 29, add, edit and delete options are available to the user.

The routine then sequences to block 562, where a decision is made as to whether a question is to be modified. If a question is to be modified, then a question is selected (564), such as one of the questions shown in FIG. 29. The user then is able to delete or modify the question and response text and associated meta data as, for example, shown in the FIG. 30 exemplary screen display.

The routine then branches back to 562 to determine whether any further questions need to be modified. After all questions that need to be modified have been modified, the routine branches to block. 568, where the user has the option to modify the questionnaire name. Thereafter, the user may generate and save the modified questionnaire locally (570) and store the modified questionnaire on the server (572), after which the routine ends (574).

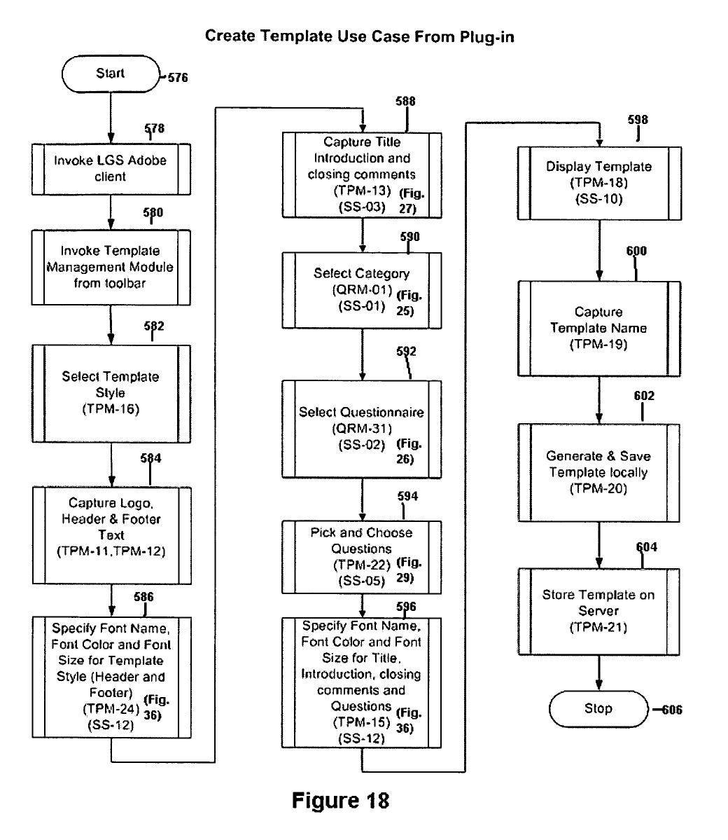

FIG. 18 is a flowchart delineating the sequence of operations involved in creating a template. Through the use of the template, the questionnaire colors, font, graphics and other features may be created. As with the prior processing, at the start of the routine (576), the Adobe client plug-in module to Adobe Acrobat is invoked in the exemplary embodiment (578). Thereafter, the template management module is invoked from the toolbar (580).

The user then has the option of selecting a template style (582). The style is specified, for example, by capturing the logo, the header and the footer text (584). Thereafter, the font name, font color and font size are selected, as, for example, shown in the exemplary screen display shown in FIG. 36 (586).

The template title, introduction and closing comments are then captured (588) using, for example, the screen display shown in FIG. 27. As shown in FIG. 27, the user is able to enter information into a title field and is permitted to add introductory and closing comments.

The user is then able to select a category of questionnaires for the template as previously described in conjunction with FIG. 25 (590). Thereafter, the user selects a particular questionnaire as previously described with respect to FIG. 26 (592). The user is also able to pick and choose questions as previously described in conjunction with the screen display in FIG. 29 (594). Thus, through the processing represented in FIG. 18, a questionnaire may become part of template.

Thereafter, the font name, font color, font size for the title, introduction, closing comments and questions may be selected as indicated in the screen display shown in FIG. 36 (596).

The created template is then displayed (598). FIG. 34 is an exemplary screen display showing a displayed template that has been created. In an illustrative embodiment, the template would have embedded code to ensure that a user of a questionnaire embodying the displayed template would be required to select, for example, one selection indicating the purchaser's level of satisfaction. In accordance with an exemplary embodiment, embedded code may also insure that a purchaser cannot submit the form unless the form is completed.

Thereafter, a template name is captured (600) and the template is generated and saved locally (602). The template is stored on the server (604) and the creation process is completed (606).

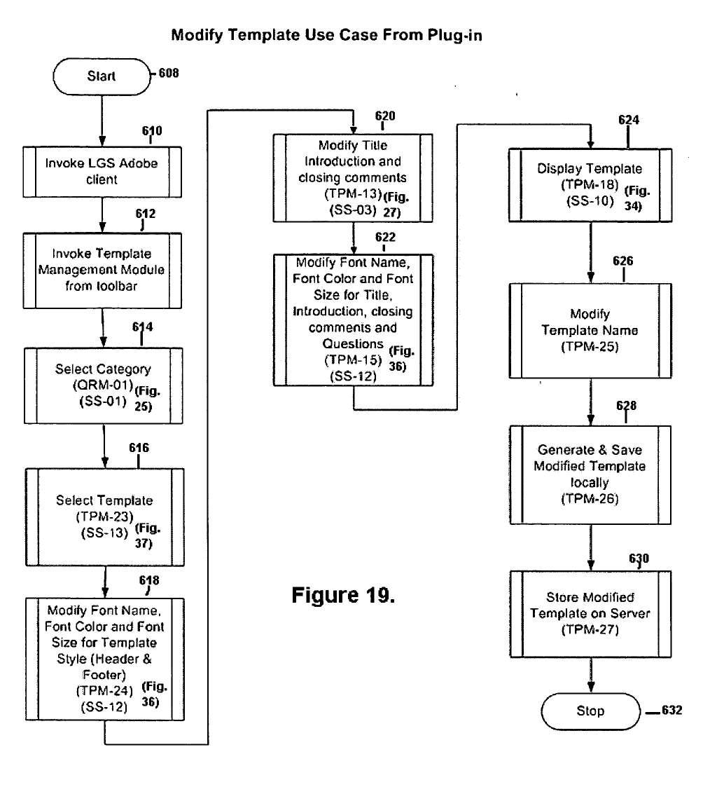

FIG. 19 is a flowchart indicating the sequence of operations involved in modifying a template. The template modification processing initially involves invoking the Adobe client plug-in as previously described (608, 610). Thereafter, the template management module is invoked (612). A category, as shown in the screen display in FIG. 25 is then selected (614). After selecting a category, a template is then selected (616) as shown in the exemplary screen display in FIG. 37.

The user is then able to modify the font name, font color, font size, for the template style (the header and footer), using, for example, the screen display such as shown in FIG. 36. Thereafter, the user is able to modify the title, introduction and closing comments (620) using the exemplary screen display shown in FIG. 27. Likewise, the user is able to modify the font name, font color, font size for title, introduction, closing comments and questions using the screen display such as shown in FIG. 36 (622). Thereafter, the template is displayed (624) as shown, for example, in FIG. 34. The user is then able to modify the template name (626). The modified template is then generated and saved locally (628). The modified template is then stored on the server (630) and the routine terminates (632).

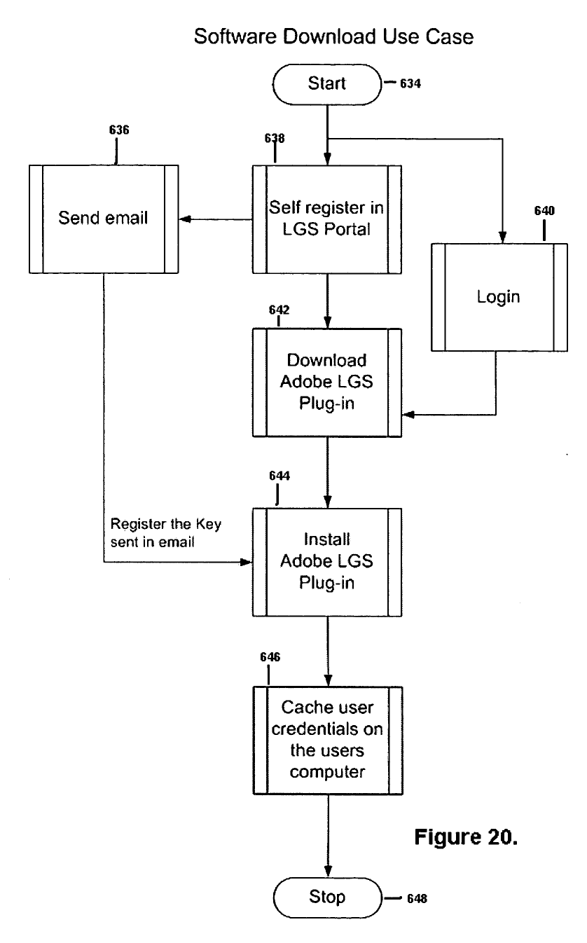

FIG. 20 is a flowchart delineating the sequence of operations involved in downloading software from, for example, the lead generation system server. Upon accessing the server (634), a user is prompted to either log in or self register (638, 640). If the user self registers in the lead generation portal, an e-mail is sent to the user (636) confirming the registration together with an indication of the user's log in key.

If the user had previously registered, the user logs in as indicated at block 640. Thereafter, the Adobe lead generation system plug in is downloaded (642), after which the Adobe lead generation system plug in is installed (644). The user is then prompted for entry of credentials which may include, for example, the user name and organization. All necessary credential information is stored in cache memory on the user's computer (646), after which the routine terminates (648). The captured information about the user will be later required by the previously described SubmitIt server 201 so that the system can determine whether the user is a partner, employee, manager, etc., for use during subsequent processing.

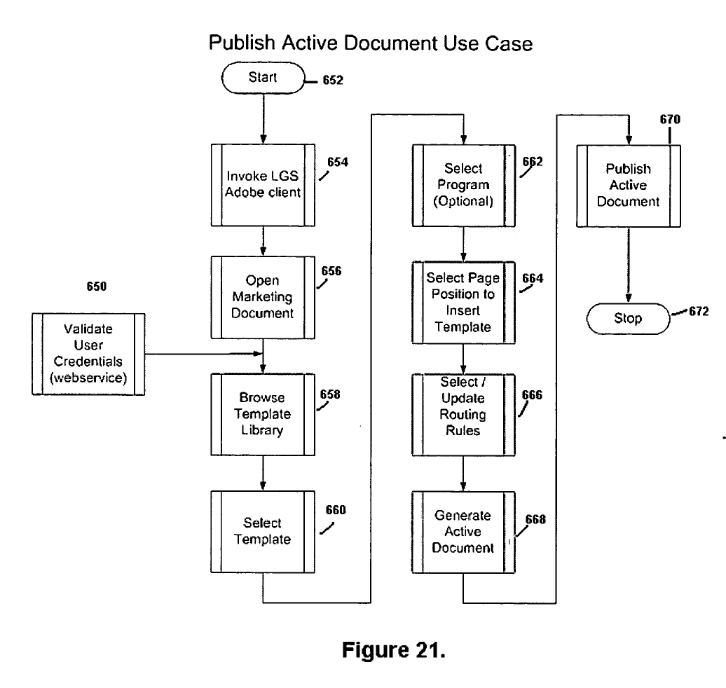

FIG. 21 is a flowchart delineating the sequence of operations that are involved in publishing an active document. Initially, during the publish active document processing, the lead generation service Adobe client plug in is invoked (652, 654). Thereafter, a marketing document is opened (656). The marketing document would, for example, comprise a PDF document which had been previously created.

The user's credentials are then validated (650). These credentials determine to which system facilities the user will have access.

Depending upon the user's credentials, the user will be able to browse the template library (658) and select a particular template to which the user is authorized to access (660).

If desired by the user, the user may select a program such as a particular marketing program (662). As indicated at block 664, the user is able to page through a document and select page positions to insert templates. In this fashion, the user is able to pick locations in the document at which, for example, a particular questionnaire is to be inserted. As described previously, this methodology may be utilized, for example, in a textbook application to insert chapter tests at the end of each chapter.

Thereafter, the user is able to select and update routing rules (666) which will determine the routing rules that are specific to a selected program, thereby permitting routing of different templates or portions of a template to different parties through different routing mechanisms.

The active document is then generated (668), whereby code is actually embedded in a selected document, for example, a marketing related PDF file. The generation of the active document results in an electronic document with a wide range of logic incorporating questionnaires, routing rules, etc. Thereafter, the active document is published by being placed on the server (670) and/or by distributing the document via other means, after which the routine terminates (672).

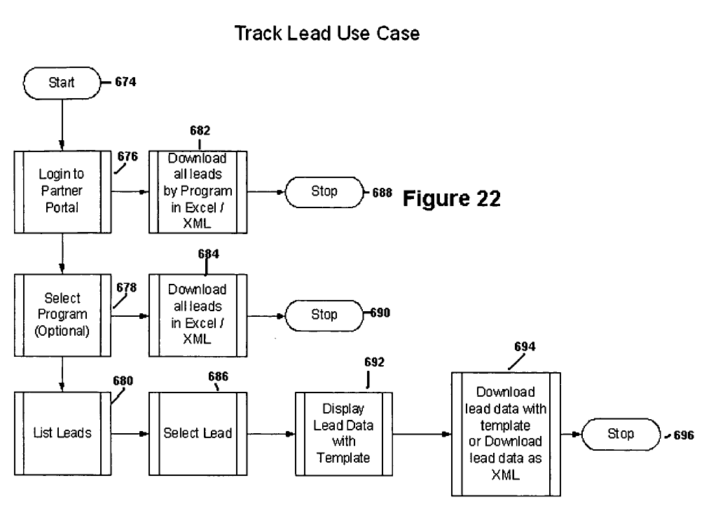

FIG. 22 is a flowchart delineating the sequence of operations involved in track lead processing. In track lead processing, once a lead is received, the system tracks it so that it can be followed up on. After a user logs on to the partner portal web site (674, 676), the user may download all leads by program into either an Excel spreadsheet or an XML document (682). In this fashion, leads may be presented in either Excel spreadsheet or XML machine readable format, after which the routine ends (688).

Alternatively, after logging in, a user may select “program” which is a subset of all the leads (678). Thereafter, such subset of leads may be downloaded in, for example, an Excel spreadsheet form or XML form (684) after which the routine terminates (690).

Rather than selecting leads for downloads, a user may receive a listing of all the leads (680) and thereafter select a particular lead (686). After selecting a specific lead, the lead data with template may be displayed (692). Thereafter, the lead data which was displayed may be downloaded with template or the lead data may be downloaded in XML format after which the routine terminates (696).

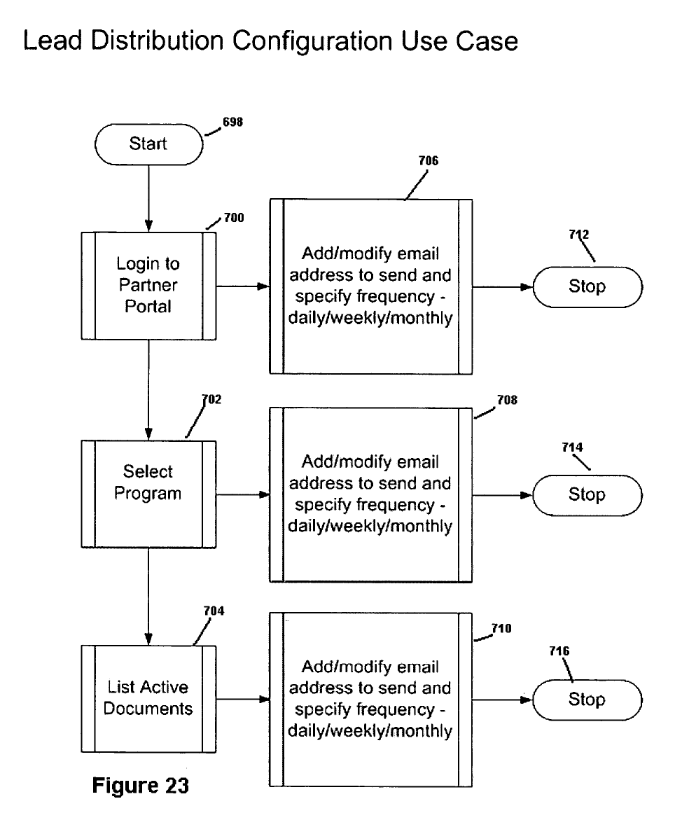

FIG. 23 is a flowchart delineating the sequence of operations involved in lead distribution configuration. Initially, a user logs on to the partner portal (698, 700). Thereafter, the user is able to configure routing information by adding or modifying e-mail addresses to send and specifying the routing frequency such as on a daily, weekly or monthly basis, after which the routine terminates (712). Alternatively, the “program” option may be selected (702). A user may then define the routing rules for the selected program (708) as indicated above by adding or modifying the e-mail address to send and by specifying the frequency on either a daily, weekly or monthly basis. Similarly, the user may obtain a list of active documents (704) and thereafter specify the routing rules by adding or modifying e-mail addresses to send and by specifying the frequency on, for example, either a daily, weekly or monthly basis, after which the routine terminates (716).

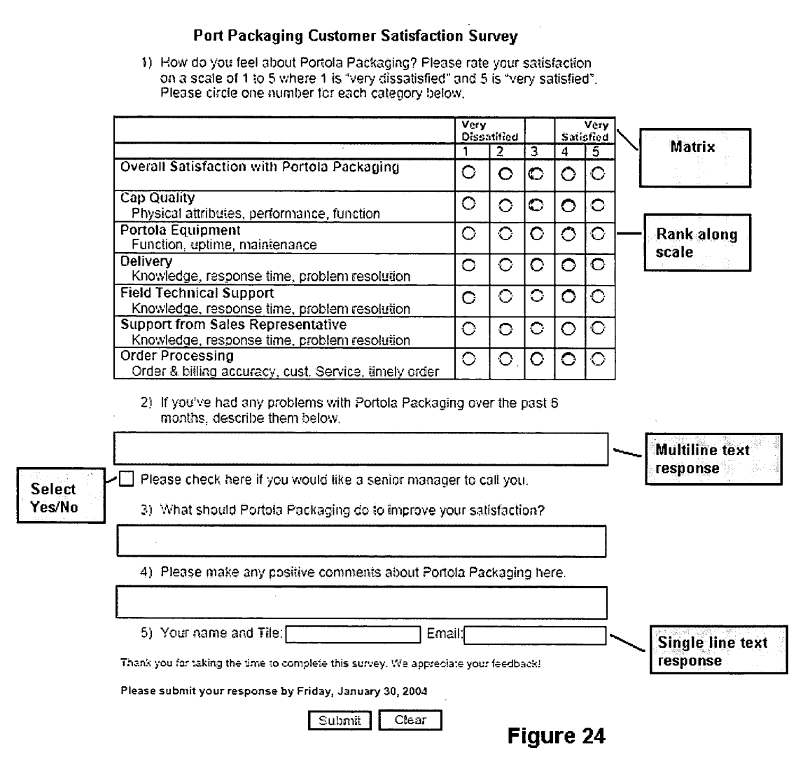

FIG. 24 is an exemplary questionnaire of a company port packaging. The questionnaire depicts different styles of questions, such as, for example, a matrix format for various questions as shown in the top portion of the questionnaire. The questionnaire also includes questions soliciting a yes/no response and questions soliciting a multi-line text response. As shown in FIG. 24, this electronic questionnaire may be submitted for processing/analysis by the system.

A wide range of further embodiments are also contemplated. For example, a further embodiment is contemplated in the form of an interactive catalog. Such an illustrative embodiment may, for example, be an active document-based electronic replacement parts catalog for an equipment manufacturer. Such an active document-based catalog could be used by a field service technician to order replacement parts for, for example, a photo copier. The system would allow the selection by, for example, a technician, among all of a company's products. After a product is selected, the system may, for example, allow for the selection of a subassembly from a diagram of the product. After the subassembly is selected, the system may, for example, display an exploded parts diagram of the subassembly, allowing the required part to be selected interactively.

If the technician was on-line, the active document would use, for example, web services to query the availability and price of the part. The technician would then confirm or reject the selection. If the selection was confirmed, a parts order eForm would be generated for the selected item. Next, the technician would be given the opportunity to make additional selections. After all selections had been made, the technician would complete the eForm, including, for example, a customer number. Next the technician would submit the eForm. If the technician were on-line the form would be submitted immediately, through web services.

If the technician were off-line, the form would be submitted via, for example, e-mail. When the eForm is processed by the SubmitIt server, the customer number would be used to retrieve the customer's email address and shipping address. An order confirmation would be generated for the customer and sent via email. Finally, the order would be forwarded to the order processing system for final processing and installation scheduling.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of processing a PDF file using at least one computer comprising the steps of:
selecting a PDF file for processing,
identifying information solicitation-related information for placement in the PDF file,
identifying at least one place in the PDF file for inserting information solicitation-related information; and
associating at least one program instruction with said PDF file for controlling obtaining responses to said information solicitation-related information.

2. A method according to claim 1, wherein said information solicitation-related information is a questionnaire.

3. A method according to claim 1, wherein said associating step includes the step of associating at least one program instruction for routing at least part of a processed version of said PDF file to at least one destination.

4. A method according to claim 1, wherein said information solicitation-related information is a form and wherein said associating step includes the step of associating at least one program instruction for prompting a user to answer a question associated with the form.

5. A method according to claim 1, further including the step of adding a form ID to the PDF form so that it may be later accessed and identified.

6. A method according to claim 1, wherein said associating step includes the step of associating at least one program instruction for adding JAVA SCRIPT to the PDF document.

7. A method according to claim 1, wherein said associating step includes the step of associating at least one program instruction for generating at least one user message.

8. A method according to claim 7, wherein said user message is a status message.

9. A method according to claim 7, wherein said user message is an error message.

10. A method according to claim 1, wherein said associating step includes the step of associating at least one program instruction for testing to determine whether said at least one computer is online.

11. A method according to claim 10, wherein said information solicitation-related information is a form, further comprising the step of automatically routing the form via the Internet to a desired location if the at least one computer is determined to be online.

12. A method according to claim 10, wherein said information solicitation-related information is a form, further comprising the step of routing the form through a store and forward mechanism if the at least one computer is not online.

13. A method according to claim 12, wherein the store and mechanism includes email.

14. A method according to claim 1, further including the step of determining whether a processed version of the PDF file is valid.

15. A method according to claim 1, further including the step of determining whether a processed version of said PDF file is valid, and automatically routing said processed version of said PDF file if said processed version of said file is valid.

16. A method according to claim 1, wherein said step of identifying information solicitation-related information includes the step of creating at least part of a questionnaire.

17. A method according to claim 1, wherein said step of identifying information solicitation-related information includes the step of selecting at least part of a questionnaire from a storage library.

18. A method according to claim 1, further including the step of processing the file so that it is in a data format compatible with a target application format.

19. A method of processing a file having a predetermined file format using at least one computer comprising the steps of:
accessing said file;
associating at least one program instruction with said file for causing the following operations:
soliciting information from a recipient of said file; and
automatically routing at least one response to an appropriate destination.

20. A method according to claim 19, further including the step of associating at least one program instruction with said file for prompting a response to the solicited information.

21. A method according to claim 19, further including the step of associating at least one program instruction with said file for causing testing to determine whether said at least one computer is online.

22. A method according to claim 21, wherein the information is solicited by presenting a form, further comprising the step of automatically routing the form via the Internet to a desired location if the at least one computer is determined to be online.

23. A method according to claim 21, wherein the information is solicited by presenting a form, further including the step of associating at least one program instruction with said file for routing the form through a store and forward mechanism if the at least one computer is not online.

24. A method according to claim 23, wherein said store and forward mechanism includes email.

25. A method according to claim 19, further including the step of determining whether the file having at least one program instruction associated therewith is valid, and
automatically routing at least a part of a processed version of said file if said processed version of file is valid.

26. A method according to claim 19, wherein said step of associating includes the step of embedding at least one program instruction in said file.

27. A method according to claim 19, which said at least one programming instruction is a Java script instruction.

28. A method of accessing and processing a file comprising the steps of:
accessing a site on a computer network by a user via a user's computer;
selecting a form having at least one program instruction associated therewith at said site, said form including fields for data entry by a user;
downloading said form to the user's computer; and
automatically routing at least a portion of a processed version of said form including at least data entered by said user to a destination in accordance with at least one program instruction associated with said form and in response to said user entering data in at least a portion of said form.

29. A method according to claim 28, wherein said step of automatically routing occurs before the user has entered all data required for completion of the form.

30. A method according to claim 29, further including the step of automatically routing the form to a destination for further data entry.

31. A method according to claim 28, wherein said step of automatically routing includes the step of sending a portion of a processed version of said form via e-mail.

32. A server computer for communicating with at least one user's computer comprising:
a memory for storing at least one file having fields for data entry by a user, said file having associated therewith at least one program instruction for soliciting information from a recipient of said file and for automatically routing at least one response to an appropriate destination; and
a processor for accessing at least one file in response to a request from a user's computer coupled thereto via a communications media, said processor being operable to download said at least one file to said user's computer in response to a user's request.

33. A server computer according to claim 32, wherein said at least one file is embedded with a questionnaire, and further including a questionnaire management subsystem.

34. A server computer according to claim 33, further including a document management subsystem for embedding instructions in electronic files.

35. A server computer according to claim 32, further including a template management subsystem for adding a predefined set of questions to said at least one file.

36. A method of obtaining information about a product comprising the steps of:
accessing a document relating to a product;
associating at least one computer readable instruction with said document operable to solicit information from a recipient of a processed version of said document;
associating at least one computer readable instruction with said document operable to receive at least one response from said recipient; and
associating at least one computer readable instruction with said document operable to route a processed version of said document to at least one next destination.

37. A method according to claim 36, wherein said document is a marketing document.

38. A method according to claim 36, further including the step of routing a processed version of said document to at least one next destination based upon a distribution list.

39. A method according to claim 36, further including the step of processing received responses to identify leads for marketing said product.

40. A method according to claim 39, further including the step of automatically routing the product lead information to a destination for responding to said lead information.

41. A method of obtaining information about a product comprising the steps of:
accessing a document relating to a product;
selecting a plurality of questions related to said product;
embedding said plurality of questions related to said product in said document;
capturing responses to said plurality of questions using at least one instruction embedded in said document; and
automatically routing a processed version of said document using at least one instruction embedded in said document.

42. A method according to claim 41, further including the step of processing received responses to identify leads for marketing said product.

43. A method according to claim 42, further including the step of automatically routing the product lead information to a destination for responding to said lead information.

44. A method of converting a static document into an active document comprising the steps of:
accessing said static document;
identifying at least one portion of said static document for insertion of information solicitation-related information;
embedding in said static document program code for presenting said information solicitation-related information; and
embedding in said static document program code for automatically routing at least one response to said information solicitation-related information to at least one destination.

45. A method according to claim 44, wherein said information solicitation-related information includes a plurality of questions and wherein said questions relate to a predetermined aspect of a product further including the step of controlling the distribution of answers to said plurality of questions to a corporate destination responsible for said predetermined aspect of said product.

46. A method according to claim 45, wherein said predetermined aspect of said product is the product's marketing, and wherein the corporate destination is the corporate marketing department.

47. A method according to claim 45, wherein said predetermined aspect of said product is the product's operation, wherein the corporate destination is the corporate quality control department.

48. A method according to claim 44, wherein said information solicitation-related information includes a plurality of questions and wherein said plurality of questions relate to a product, further including the step of collecting information regarding potential customer names.

49. A method according to claim 44, wherein said information solicitation-related information includes a plurality of questions and wherein said plurality of questions relate to a product, further including the step of collecting information concerning opinions about the product.

50. A method of processing a file using at least one computer comprising the steps of:
selecting a file for processing,
identifying form-related information for associating with the file,
identifying at least one place in the file for associating form-related information; and
associating at least one program instruction with said file relating to form completion by a user.

51. A method according to claim 50, wherein said form-related information is a questionnaire.

52. A method according to claim 50 wherein said associating step includes the step of associating at least one program instruction for routing at least part of a processed version of said file to at least one destination.

53. A method according to claim 50, wherein said form-related information is a form and wherein said associating step includes the step of associating at least one program instruction for prompting a user to answer a question associated with the form.

54. A method according to claim 53, further including the step of associating validation code relating to an answer to a question.

55. A method according to claim 54, where said validation code is used to determine whether an answer is acceptable.

56. A method according to claim 50, further including the step of adding a form ID to the file so that it may be later accessed and identified.

57. A method according to claim 50, wherein said associating step includes the step of associating at least one program instruction for adding JAVA SCRIPT to the file.

58. A method according to claim 50, wherein said associating step includes the step of associating at least one program instruction for generating at least one user message.

59. A method according to claim 50, wherein said associating step includes the step of associating at least one program instruction for testing to determine whether said at one computer is online.

60. A method according to claim 59, further comprising the step of automatically routing the form via the Internet to a desired location if the at least one computer is determined to be online.

61. A method according to claim 60, further comprising the step of routing the form through a store and forward mechanism if the at least one computer is not online.

62. A method according to claim 61, wherein said store and forward mechanism includes email.

63. A method according to claim 50, wherein said step of identifying form-related information includes the step of creating at least part of a form.

64. A method according to claim 50, wherein said step of identifying form-related information includes the step of selecting at least part of a questionnaire from a storage library.

65. A method of processing a file with a user's computer comprising the steps of:
receiving a form having at least one program instruction associated therewith at said user's computer, said form including fields for data entry by a user; and
automatically routing at least a portion of a processed version of said form including at least data entered by said user to a destination in accordance with at least one program instruction associated with said form and in response to said user entering data in at least a portion of said form.

66. A method according to claim 65, wherein said step of automatically routing occurs before the user has entered all data required for completion of the form.

67. A method according to claim 66, further including the step of automatically routing the form to a destination for further data entry.

68. A method according to claim 65, wherein said step of automatically routing includes the step of sending a portion of a processed version of said form via e-mail.

69. A method according to claim 65, further including the step of processing the file so that it is in a data format compatible with a target application format.

70. A method according to claim 65, wherein said step of receiving includes receiving the file by email.

71. A method according to claim 65, wherein said receiving step includes the step of downloading said form from a server.
